(19) United States
(12) Patent Application Publication
(10) Pub. No.: US 2026/0019022 A1
(43) Pub. Date: Jan. 15, 2026

(54) CONTROL APPARATUS FOR THREE-LEVEL INVERTER

(71) Applicant: DENSO CORPORATION, Kariya-city (JP)

(72) Inventors: Shusei NISHIMURA, Nisshin-city (JP); Junichi FUKUTA, Kariya-city (JP)

(73) Assignee: DENSO CORPORATION, Kariya-city (JP)

(21) Appl. No.: 19/335,302

(22) Filed: Sep. 22, 2025

Related U.S. Application Data
(63) Continuation of application No. PCT/JP2024/006216, filed on Feb. 21, 2024.

(30) Foreign Application Priority Data
Mar. 21, 2023 (JP) 2023-044830

(51) Int. Cl. H02P 27/12; H02P 21/22

(52) U.S. Cl. CPC H02P 27/12; H02P 21/22

(57) ABSTRACT

A control apparatus is applicable to a system which includes first and second power storage units connected in series with each other, a rotating electric machine and a three-level inverter. Two different drive states of switches of the three-level inverter are defined as specific drive states. The control apparatus includes: a selection unit configured to select a drive pattern, which is a combination of drive states of the switches in a switching cycle, such that both a duration for which the switches are set to one of the specific drive states and a duration for which the switches are set to the other of the specific drive states occur within the switching cycle; and a switch control unit configured to perform switching control of the switches based on the selected drive pattern.

### CROSS-REFERENCE TO RELATED APPLICATIONS

The present application is a continuation application of International

Application No. PCT/JP2024/006216 filed on Feb. 21, 2024, which is based on and claims priority from Japanese Patent Application No. 2023-044830 filed on Mar. 21, 2023. The entire contents of these applications are incorporated by reference into the present application.

### BACKGROUND

### 1 Technical Field

The present disclosure relates to control apparatuses for three-level inverters.

### 2 Description of Related Art

Conventionally, control apparatuses have been known which are configured to turn on and off switches included in a three-level inverter. Specifically, the control apparatuses are configured to turn on and off the switches through space vector modulation control. Moreover, to a DC side of the three-level inverter, there are connected a first power storage unit and a second power storage unit that are connected in series with each other. The control apparatuses perform switching control so as to keep both the voltage of the first power storage unit and the voltage of the second power storage unit within a predetermined range. Consequently, the application of an overvoltage to the switches can be prevented.

### SUMMARY

According to the present disclosure, there is provided a control apparatus for a three-level inverter, the control apparatus being applicable to a system comprising:
a first power storage unit and a second power storage unit that are connected in series with each other;
a rotating electric machine having three windings respectively corresponding to three phases; and
the three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control apparatus comprising:
a selection unit configured to select, based on a command voltage for controlling a controlled variable of the rotating electric machine to a command value, a drive pattern that is a combination of drive states of the switches in a switching cycle; and
a switch control unit configured to perform switching control of the switches based on the selected drive pattern,
wherein:
two different ones of the drive states of the switches are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states; and
the selection unit is further configured to select, based on the command voltage, the drive pattern such that both a duration for which the switches are set to one of the specific drive states and a duration for which the switches are set to the other of the specific drive states occur within the switching cycle.

### BRIEF DESCRIPTION OF THE DRAWINGS

FIG. 1 is a configuration diagram of a motor control system according to a first embodiment.

FIG. 2 is a functional block diagram illustrating processes performed by a control apparatus.

FIG. 3 is a diagram illustrating a vector space.

FIG. 4 is a diagram for explaining a voltage vector.

FIG. 5 is a diagram illustrating an electric current path during a duration for which switches are set to an HMM drive state.

FIG. 6 is a diagram illustrating an electric current path during a duration for which the switches are set to an MLL drive state.

FIG. 7 is a diagram illustrating an example of drive patterns of the switches.

FIG. 8 is a flowchart illustrating steps of a control process performed by the control apparatus.

FIG. 9 is a diagram for explaining a specific region and a voltage control region.

FIG. 10 shows time charts illustrating examples of switching control.

FIG. 11 is a configuration diagram of a motor control system according to a second embodiment.

### DESCRIPTION OF EMBODIMENTS

With the above-described conventional control apparatuses (see, for example, Japanese Patent Application Publication No. JP H09-37592 A), there is a concern that the period of variation in the voltages of the first and second power storage units may become long, causing the controllability of the voltages of the power storage units to be lowered.

The present disclosure has been accomplished in view of the above problem with the conventional control apparatuses.

In the above-described control apparatus according to the present disclosure, a drive pattern, which is a combination of drive states of the switches in a switching cycle, is selected based on the command voltage. Specifically, the drive pattern is selected, based on the command voltage, such that both a duration for which the switches are set to one of the specific drive states and a duration for which the switches are set to the other of the specific drive states occur within the switching cycle. Then, the switching control of the switches is performed based on the selected drive pattern. In this case, the directions of changes in the voltages of the first and second power storage units during the duration for which the switches are set to one of the specific drive states are opposite to those during the duration for which the switches are set to the other of the specific drive states. Consequently, it becomes possible to have the voltages of the first and second power storage units varying at shorter intervals and thereby shorten the period of variation in the voltages of the first and second power storage units in comparison with the case where only the duration for which the switches are set to either of the specific drive states occurs within one switching cycle. As a result, it becomes possible to improve the controllability of the voltages of the first and second power storage units.

### First Embodiment

Hereinafter, a first embodiment embodying the control apparatus according to the present disclosure will be described with reference to the drawings. In the present embodiment, the control apparatus is installed in an electrified vehicle such as an electric vehicle or a hybrid vehicle.

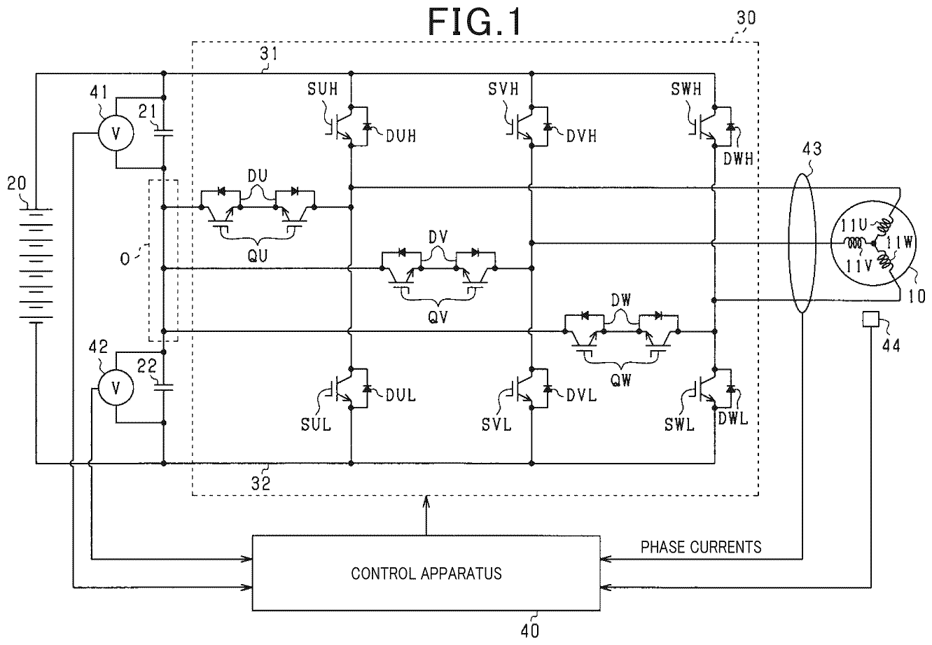

As shown in FIG. 1, a motor control system includes a rotating electric machine 10, a battery 20, an inverter 30 and a control apparatus 40. The rotating electric machine 10 is an in-vehicle main machine, and is configured so that mechanical power can be transmitted between it and drive wheels (not shown) of the vehicle. More particularly, in the present embodiment, the rotating electric machine 10 is configured as a three-phase synchronous machine which includes, as stator windings, a U-phase winding 11U, a V-phase winding 11V and a W-phase winding 11W that are star-connected together. The phase windings 11U, 11V and 11W are arranged in such a manner as to be offset from each other by 120° in electrical angle. In addition, the rotating electric machine 10 may be configured as, for example, a permanent magnet synchronous machine.

The battery 20 is electrically connected with the rotating electric machine 10 via the inverter 30. In the present embodiment, the battery 20 is implemented by an assembled battery that is constituted of battery cells connected in series with each other. In addition, secondary battery cells, such as lithium-ion battery cells may be employed as the battery cells constituting the battery 20. The terminal voltage of the battery 20 may be, for example, 100V or higher.

The inverter 30 is constituted of an electric power conversion circuit that converts, through switching operation, DC power supplied from the battery 20 into three-phase AC power and supplies the resultant three-phase AC power to the rotating electric machine 10. On the battery 20 side of the inverter 30, there are provided a first capacitor 21 and a second capacitor 22 as power storage units. The first capacitor 21 and the second capacitor 22 are connected in series with each other. The battery 20 is connected in parallel with the series connection unit of the first and second capacitors 21 and 22. In the present embodiment, the capacitance of the first capacitor 21 and the capacitance of the second capacitor 22 are set to the same value. In addition, the first capacitor 21 and the second capacitor 22 may be either provided outside the inverter 30 or built in the inverter 30.

In the present embodiment, the inverter 30 is configured as a T-type three-level inverter. Specifically, the inverter 30 includes three series connection units respectively corresponding to three phases and each consisting of a corresponding one of upper-arm switches SUH, SVH and SWH and a corresponding one of lower-arm switches SUL, SVL and SWL. Each of the switches SUH to SWL is implemented by a voltage-controlled semiconductor switching element, more particularly by an IGBT. Therefore, each of the switches SUH to SWL has its higher-potential-side terminal serving as a collector and its lower-potential-side terminal serving as an emitter. In addition, each of the switches SUH, SVH, SWH, SUL, SVL and SWL has a corresponding one of freewheel diodes DUH, DVH, DWH, DUL, DVL and DWL connected in antiparallel thereto.

The emitter of the U-phase upper-arm switch SUH is connected with the collector of the U-phase lower-arm switch SUL. A junction point between the U-phase upper-arm switch SUH and the U-phase lower-arm switch SUL is connected with a first end of the U-phase winding 11U. The emitter of the V-phase upper-arm switch SVH is connected with the collector of the V-phase lower-arm switch SVL. A junction point between the V-phase upper-arm switch SVH and the V-phase lower-arm switch SVL is connected with a first end of the V-phase winding 11V. The emitter of the W-phase upper-arm switch SWH is connected with the collector of the W-phase lower-arm switch SWL. A junction point between the W-phase upper-arm switch SWH and the W-phase lower-arm switch SWL is connected with a first end of the W-phase winding 11W. Second ends of the U-phase, V-phase and W-phase windings 11U, 11V and 11W are connected with each other.

The collectors of the upper-arm switches SUH to SWH are connected by a positive-electrode-side bus 31 such as a busbar. The positive-electrode-side bus 31 is connected with a positive electrode terminal of the battery 20 and a first end of the first capacitor 21. A second end of the first capacitor 21 is connected with a first end of the second capacitor 22 via a neutral point O. The emitters of the lower-arm switches SUL to SWL are connected by a negative-electrode-side bus 32 such as a busbar. The negative-electrode-side bus 32 is connected with a negative electrode terminal of the battery 20 and a second end of the second capacitor 22.

The inverter 30 further includes clamp switches QU, QV and QW that perform conduction and interruption of electric current in both directions. In the present embodiment, each of switches constituting the clamp switches QU, QV and QW is implemented by a voltage-controlled semiconductor switching element, more particularly by an IGBT. Moreover, each of the switches constituting the clamp switches QU, QV and QW has a corresponding one of freewheel diodes DU, DV and DW connected in antiparallel thereto.

Specifically, taking the U-phase as an example, the two switches constituting the U-phase clamp switch QU have their emitters connected with each other. Moreover, one of the two switches constituting the U-phase clamp switch QU has its collector connected with a junction point between the U-phase upper-arm switch SUH and the U-phase lower-arm switch SUL; and the other of the two switches constituting the U-phase clamp switch QU has its collector connected with the neutral point O. Each of the U-phase, V-phase and W-phase clamp switches QU, QV and QW allows flow of electric current in both directions when it is turned on, and interrupts flow of electric current in both directions when it is turned off. It should be noted that each of the U-phase, V-phase and W-phase clamp switches QU, QV and QW may alternatively be configured to have the collectors of the two switches constituting the clamp switch connected with each other. It also should be noted that each of the switches constituting the clamp switches QU, QV and QW may alternatively be implemented by a Reverse Blocking IGBT (RB-IGBT).

The motor control system further includes a first voltage sensor 41, a second voltage sensor 42, a phase current sensor 43 and a rotation angle sensor 44. The first voltage sensor 41 detects the voltage of the first capacitor 21. The second voltage sensor 42 detects the voltage of the second capacitor 22. The phase current sensor 43 detects U-phase, V-phase and W-phase currents flowing through the respective phase windings 11U, 11V and 11W. It should be noted that the phase current sensor 43 is required to be capable of detecting at least two of the U-phase, V-phase and W-phase currents. The rotation angle sensor 44 may be implemented by, for example, a resolver. The rotation angle sensor 44 detects the electrical angle of the rotating electric machine 10. The detection values of the sensors 41 to 44 are inputted to the control apparatus 40.

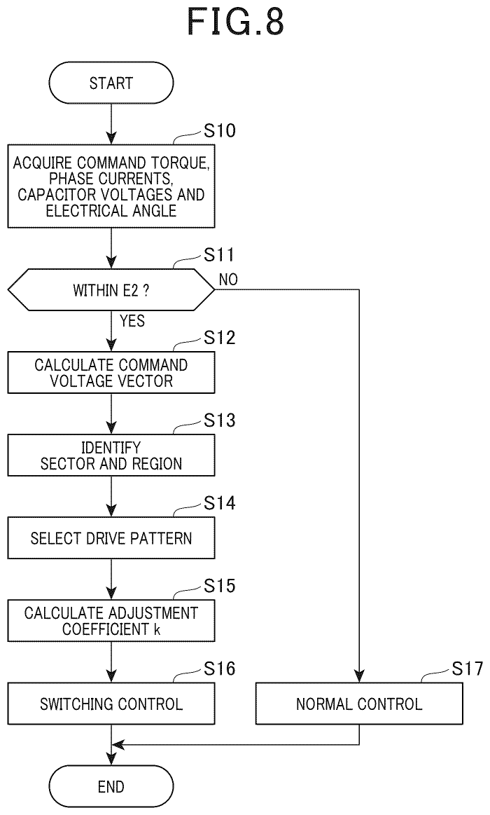

The control apparatus 40 is mainly composed of a microcomputer which includes a CPU and various memories. The functions of the microcomputer may be provided by software recorded in a tangible memory device and a computer that executes it, only software, only hardware, or a combination thereof. For example, in the case of the microcomputer being configured with an electronic circuit that is hardware, it may be configured with a digital circuit that includes a number of logic circuits, or with an analog circuit. For example, the microcomputer may execute programs stored in a non-transitory tangible storage medium that is provided in the microcomputer as a storage unit. The programs may include, for example, a program for performing a control process shown in FIG. 8 which will be described later. Moreover, methods corresponding to the programs may be carried out by executing the programs. The storage unit may be, for example, a nonvolatile memory. In addition, the programs stored in the storage unit may be downloaded and updated, for example by OTA (Over-The-Air), via a communication network such as the Internet.

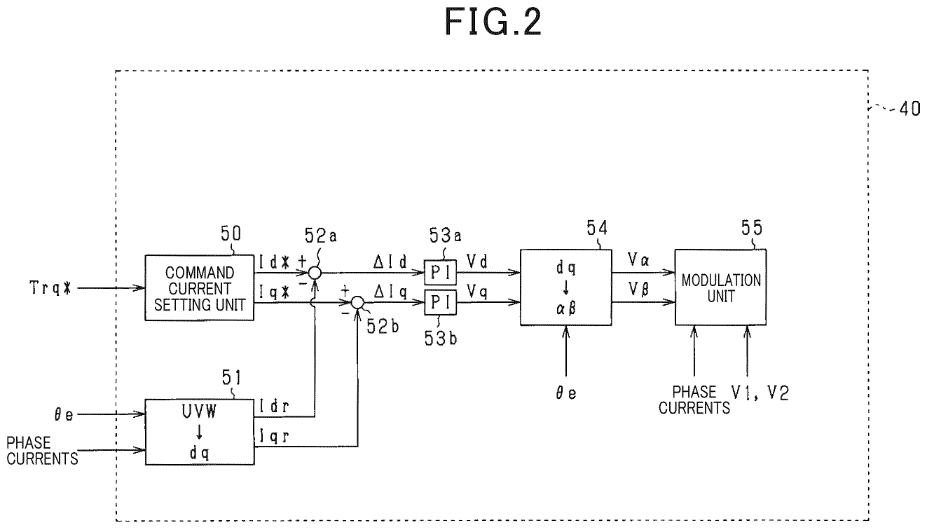

The control apparatus 40 performs switching control for turning on and off the switches SUH to SWL and QU to QW of the inverter 30 and thereby controlling a controlled variable of the rotating electric machine 10 to a command value. Hereinafter, the switching control performed by the control apparatus 40 will be described with reference to FIG. 2. In the example of the switching control shown in FIG. 2, electric current feedback control is performed. Moreover, the controlled variable is the torque of the rotating electrical machine 10; and the command value is a command torque Trq* inputted from a host control apparatus.

The control apparatus 40 includes a command current setting unit 50. The command current setting unit 50 sets d-axis and q-axis command currents Id* and Iq* based on the command torque Trq*. For example, the command current setting unit 50 may set the d-axis and q-axis command currents Id* and Iq* based on map information or formula information; the map information or formula information associates the command torque Trq* with the d-axis and q-axis command currents Id* and Iq*

The control apparatus 40 also includes a two-phase conversion unit 51. The two-phase conversion unit 51 converts, based on the U-phase, V-phase and W-phase currents flowing through the respective phase windings 11U, 11V and 11W and the electrical angle Oe of the rotating electric machine 10, the U-phase, V-phase and W-phase currents in a three-phase fixed coordinate system into d-axis current Idr and q-axis current Iqr in a two-phase rotating coordinate system (i.e., d-q coordinate system). In addition, the two-phase conversion unit 51 can use the detection values of the phase current sensor 43 as the phase currents and the detection value of the rotation angle sensor 44 as the electrical angle θe.

The control apparatus 40 further includes a d-axis deviation calculation unit 52a and a q-axis deviation calculation unit 52b. The d-axis deviation calculation unit 52a calculates a d-axis current deviation ΔId by subtracting the d-axis current Idr from the d-axis command current Id*. The q-axis deviation calculation unit 52b calculates a q-axis current deviation ΔIq by subtracting the q-axis current Iqr from the q-axis command current Iq*.

The control apparatus 40 further includes a d-axis command voltage calculation unit 53a and a q-axis command voltage calculation unit 53b. The d-axis command voltage calculation unit 53a calculates, based on the d-axis current deviation ΔId, a d-axis command voltage Vd as a manipulated variable for feedback-controlling the d-axis current Idr to the d-axis command current Id*. The q-axis command voltage calculation unit 53b calculates, based on the q-axis current deviation ΔIq, a q-axis command voltage Vq as a manipulated variable for feedback-controlling the q-axis current Iqr to the q-axis command current Iq *. In addition, the feedback control used in the d-axis command voltage calculation unit 53a and the q-axis command voltage calculation unit 53b may be, for example, proportional-integral control.

The control apparatus 40 further includes a fixed coordinate conversion unit 54. The fixed coordinate conversion unit 54 converts, based on the d-axis and q-axis command voltages Vd and Vq outputted from the d-axis and q-axis command voltage calculation units 53a and 53b and the electrical angle θe, the d-axis and q-axis command voltages Vd and Vq in the two-phase rotating coordinate system into α-axis and β-axis command voltages Vα and Vβ in a two-phase fixed coordinate system. In addition, the fixed coordinate conversion unit 54 can use the detection value of the rotation angle sensor 44 as the electrical angle θe.

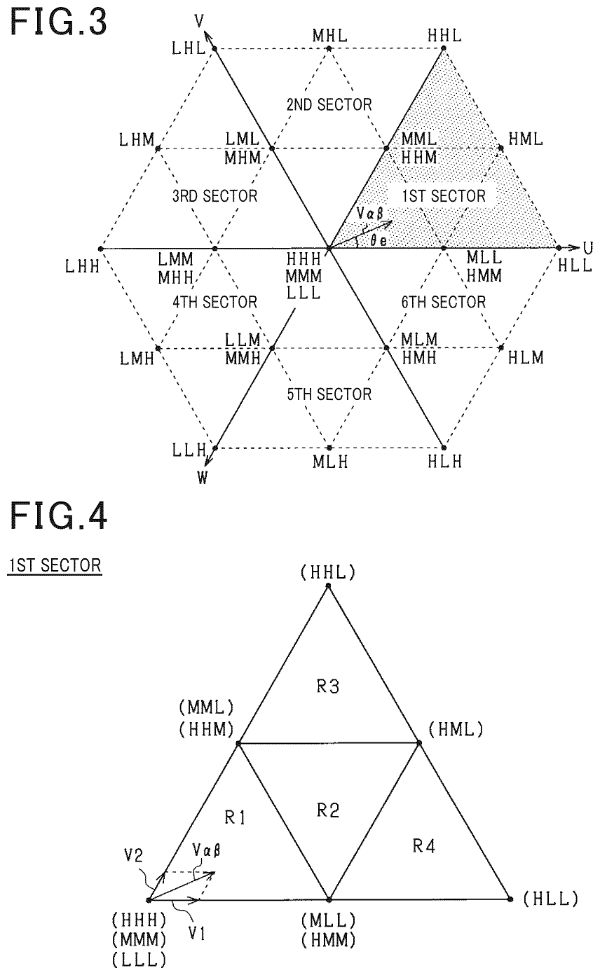

The control apparatus 40 further includes a modulation unit 55. The modulation unit 55 sets a voltage vector, which is determined by the α-axis and β-axis command voltages Vα and Vβ, as a command voltage vector Vαβ for controlling the controlled variable of the rotating electric machine 10 to the command value. Then, the modulation unit 55 identifies the sector in which the command voltage vector Vαβ exists and the existence region of the command voltage vector Vαβ within the sector. The vector space in which the command voltage vector Vαβ can exist is divided into six sectors in connection with the argument of the command voltage vector Vαβ. The argument of the command voltage vector Vαβ is the angle between the command voltage vector Vαβ and the U-phase axis, and specifically is the electrical angle θe. The sign of the electrical angle θe is defined to be positive in the left-handed (or counterclockwise) direction. FIG. 3 shows the first to sixth sectors, i.e., the six sectors into which the vector space is divided. In the vector space, the U-phase, V-phase and W-phase axes are located offset from each other by 120° in electrical angle. Each of the sectors is a region between the axes of two phases having an electrical angle difference of 60° therebetween. In addition, in FIG. 3, the region representing the first sector is dot-hatched.

Each of the first to sixth sectors are further divided into four existence regions. Specifically, the endpoint of the sector on that one of the axes of the two phases demarcating the sector which represents a smaller argument is defined as a first endpoint; the endpoint of the sector on the other of the axes of the two phases demarcating the sector which represents a larger argument is defined as a second endpoint; the midpoint between the origin of the vector space and the first endpoint is defined as a first midpoint; the midpoint between the origin of the vector space and the second endpoint is defined as a second midpoint; and the midpoint between the first endpoint and the second endpoint is defined as a middle endpoint. The first region R1 denotes the region surrounded by a triangle whose vertices are the origin of the vector space, the first midpoint and the second midpoint. The second region R2 denotes the region surrounded by a triangle whose vertices are the first midpoint, the second midpoint and the middle endpoint. The third region R3 denotes the region surrounded by a triangle whose vertices are the second endpoint, the second midpoint and the middle endpoint. The fourth region R4 denotes the region surrounded by a triangle whose vertices are the first endpoint, the first midpoint and the middle endpoint. FIG. 4 shows, taking the first sector as an example, the first to fourth regions R1 to R4 as the existence regions. In addition, in the first sector, the first endpoint represents a drive state HLL; the second endpoint represents a drive state HHL; the first midpoint represents both a drive state MLL and a drive state HMM; the second midpoint represents both a drive state MML and a drive state HHM; and the middle endpoint represents a drive state HML.

The modulation unit 55 identifies, based on the electrical angle de, the sector in which the command voltage vector Vαβ exists. For example, when 0°≤θe<60°, the modulation unit 55 identifies the command voltage vector Vαβ as existing in the first sector. Further, the modulation unit 55 identifies the existence region of the command voltage vector Vαβ within the sector based on the magnitude of the command voltage vector Vαβ and the angles thereof within the sector. For example, the modulation unit 55 may identify, based on information (specifically, map information or formula information) that associates the magnitude of the command voltage vector Vαβ and the angles thereof within the sector with the first to fourth regions R1 to R4 (i.e., the existence regions) within the sector, in which one of the first to fourth regions R1 to R4 the command voltage vector Vαβ exists. In addition, the angles of the command voltage vector Vαβ within the sector is calculated based on the electrical angle θe and the sector number.

The modulation unit 55 specifies a drive state of the switches SUH to SWL and QU to QW each time based on the identified sector and existence region of the command voltage vector Vαβ. In addition, all the drive states of the switches SUH to SWL and QU to QW which can be realized by the inverter 30 are specified as shown in FIG. 3.

Each drive state of the switches SUH to SWL and QU to QW is represented by a set of phase voltages; and each of the phase voltages is represented by three levels H, M and L. Each phase voltage of the level His a voltage of the subject phase which is outputted when a corresponding one of the upper-arm switches SUH, SVH and SWH is in an ON state and both a corresponding one of the lower-arm switches SUL, SVL and SWL and a corresponding one of the clamp switches QU, QV and QW are in an OFF state. Each phase voltage of the level Mis a voltage of the subject phase which is outputted when a corresponding one of the clamp switches QU, QV and QW is in an ON state and both a corresponding one of the upper-arm switches

SUH, SVH and SWH and a corresponding one of the lower-arm switches SUL, SVL and SWL are in an OFF state. Each phase voltage of the level L is a voltage of the subject phase which is outputted when a corresponding one of the lower-arm switches SUL, SVL and SWL is in an ON state and both a corresponding one of the upper-arm switches SUH, SVH and SWH and a corresponding one of the clamp switches QU, QV and QW are in an OFF state.

For example, the drive state HML is a drive state in which: the U-phase voltage is at the level H; the V-phase voltage is at the level M; and the W-phase voltage is at the level L. That is, in the drive state HML, the U-phase upper-arm switch SUH, the V-phase clamp switch QV and the W-phase lower-arm switch SWL are in an ON state, whereas the V-phase and W-phase upper-arm switches SVH and SWH, the U-phase and W-phase clamp switches QU and QW and the U-phase and V-phase lower-arm switches SUL and SVL are in an OFF state.

In addition, when the voltage of the battery 20 is VH and the electric potential of the neutral point O is a reference electric potential of OV, each phase voltage of the level H is VH/2; each phase voltage of the level M is 0; and each phase voltage of the level Lis-VH/2.

At the origin of the vector space, the switches SUH to SWL and QU to QW are in the drive state HHH, the drive state MMM or the drive state LLL regardless of the sectors. In other words, at the origin of the vector space, the switches SUH to SWL and QU to QW are in a drive state in which all the phase windings 11U to 11W are connected with the first end of the first capacitor 21, with the neutral point O or with the second end of the second capacitor 22. Hereinafter, the drive states HHH, MMM and LLL will be referred to as zero-voltage drive states.

As shown in FIGS. 3 and 4, the positions of two different drive states MML and HHM of the switches SUH to SWL and QU to QW in the vector space are the same. Moreover, the three line-to-line voltages between the phase windings 11U to 11W (i.e., the U-V phase voltage, the V-W phase voltage and the W-U phase voltage) in one of the two drive states MML and HHM are equal to those in the other of the two drive states MML and HHM. In addition, the line-to-line voltages applied between the phase windings 11U to 11W in the two drive states MML and HHM may vary with variation in the voltages of the first and second capacitors 21 and 22; however, when the voltages of the first and second capacitors 21 and 22 are within a predetermined range, the line-to-line voltages applied between the phase windings 11U to 11W in one of the two drive states MML and HHM are equal to those in the other of the two drive states MML and HHM. The predetermined range for the voltages of the first and second capacitors 21 and 22 is determined in consideration of, for example, the controllability of the rotating electric machine 10 and the reliability of the switches SUH to SWL and QU to QW. Similarly, the positions of two different drive states MLL and HMM of the switches SUH to SWL and QU to QW in the vector space are the same; and the line-to-line voltages in one of the two drive states MLL and HMM are equal to those in the other of the two drive states MLL and HMM.

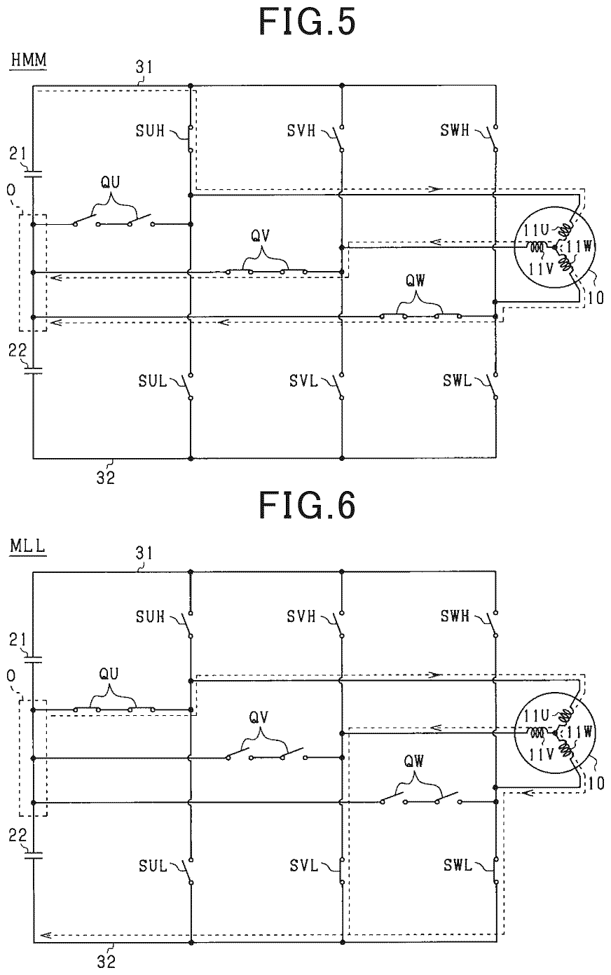

FIGS. 5 and 6 respectively illustrate examples of electric current paths in the two different drive states HMM and MLL. It should be noted that these figures illustrate electric current paths when the voltages of the first and second capacitors 21 and 22 are higher than the U-V phase voltage and the W-U phase voltage. As shown in these figures, in each of the drive states HMM and MLL, the U-phase current flows from the side of the U-phase switches SUH, SUL and QU to the U-phase winding 11U; the V-phase current flows from the V-phase winding 11V to the side of the V-phase switches SVH, SVL and QV; and the W-phase current flows from the W-phase winding 11W to the side of the W-phase switches SWH, SWL and QW. Moreover, as shown in FIG. 5, during a duration for which the switches SUH to SWL and QU to QW are set to the drive state HMM, electric current flows into the neutral point O. On the other hand, as shown in FIG. 6, during a duration for which the switches SUH to SWL and QU to QW are set to the drive state MLL, electric current flows out from the neutral point O. That is, the direction of the electric current flowing through the neutral point O during the duration for which the switches SUH to SWL and QU to QW are set to the drive state HMM is opposite to the direction of the electric current flowing through the neutral point O during the duration for which the switches SUH to SWL and QU to QW are set to the drive state MLL. Similarly, the direction of electric current flowing through the neutral point O during a duration for which the switches SUH to SWL and QU to QW are set to the drive state MML is opposite to the direction of electric current flowing through the neutral point O during a duration for which the switches SUH to SWL and QU to QW are set to the drive state HHM.

That is, for the two different drive states MML and HHM or MLL and HMM of the switches SUH to SWL and QU to QW, the line-to-line voltages in one of the two different drive states are equal to those in the other of the two different drive states; and the direction of the electric current flowing through the neutral point O in one of the two different drive states is opposite to that in the other of the two different drive states. Hereinafter, the drive states MML and HHM and the drive states MLL and HMM will be referred to as specific drive states of the switches SUH to SWL and QU to QW. In addition, the drive states LML and MHM, the drive states LMM and MHH, the drive states LLM and MMH and the drive states MLM and HMH are also specific drive states.

The modulation unit 55 decomposes the command voltage vector Vαβ into a plurality of voltage vectors. Specifically, the command voltage vector Vαβ is decomposed into voltage vectors corresponding to the vertices of the existence region of the command voltage vector Vαβ. Then, based on the magnitudes of the voltage vectors into which the command voltage vector Vαβ is decomposed, the modulation unit 55 calculates durations, for which the switches SUH to SWL and QU to QW are set to the drive states corresponding to the voltage vectors, in one switching cycle of the switches SUH to SWL and QU to QW. In addition, one switching cycle is a period for averaging the voltage vectors that are outputted each time for a predetermined duration. Further, the modulation unit 55 generates drive commands for turning on and off the switches SUH to SWL and QU to QW so as to set the switches SUH to SWL and QU to QW to the drive states respectively for the calculated durations in one switching cycle. Then, the switches SUH to SWL and QU to QW are driven based on the drive commands, thereby causing an average voltage vector, which is an average of the voltage vectors in one switching cycle, to be outputted from the inverter 30.

For example, as shown in FIG. 4, in the case of the command voltage vector Vαβ being identified as existing in the first region R1 of the first sector, the command voltage vector Vαβ is decomposed into a voltage vector V1 corresponding to the drive states MLL and HMM and a voltage vector V2 corresponding to the drive states MML and HHM. More specifically, V1 is a vector that is obtained by multiplying the voltage vector representing the drive states MLL and HMM by ta (0<ta<1); and V2 is a vector that is obtained by multiplying the voltage vector representing the drive states MML and HHM by tb (0<tb<1). In this case, the duration for which the switches SUH to SWL and QU to QW are set to the drive state MLL or HMM is ta×TS and the duration for which the switches SUH to SWL and QU to QW are set to the drive state MML or HHM is tb×TS, where TS represents the length of one switching cycle. In addition, for periods other than the durations ta×TS and tb×TS in one switching cycle, the switches SUH to SWL and QU to QW are set to the drive state HHH, MMM or LLL.

Moreover, in the case of the command voltage vector Vαβ being identified as existing in the second region R2 of the first sector, the command voltage vector Vαβ is decomposed into a voltage vector corresponding to the drive states MLL and HMM, a voltage vector corresponding to the drive states MML and HHM and a voltage vector corresponding to the drive state HML. In the case of the command voltage vector Vαβ being identified as existing in the third region R3 of the first sector, the command voltage vector Vαβ is decomposed into a voltage vector corresponding to the drive states MML and HHM, a voltage vector corresponding to the drive state HML and a voltage vector corresponding to the drive state HHL. In the case of the command voltage vector Vαβ being identified as existing in the fourth region R4 of the first sector, the command voltage vector Vαβ is decomposed into a voltage vector corresponding to the drive states MLL and HMM, a voltage vector corresponding to the drive state HML and a voltage vector corresponding to the drive state HLL. Then, based on the magnitudes of the voltage vectors into which the command voltage vector Vαβ is decomposed, durations for which the switches SUH to SWL and QU to QW are set to the drive states corresponding to the voltage vectors are calculated.

In the case of the command voltage vector Vαβ being identified as existing in one of the second to sixth sectors, the same processes are performed as in the case of the command voltage vector Vαβ being identified as existing in the first sector. For example, in the case of the command voltage vector Vαβ being identified as existing in the first region R1 of the second sector, the command voltage vector Vαβ is decomposed into a voltage vector corresponding to the drive states HHH, MMM and LLL, a voltage vector corresponding to the drive states MML and HHM and a voltage vector corresponding to the drive states LML and MHM. Then, based on the magnitudes of the voltage vectors into which the command voltage vector Vαβ is decomposed, a duration for which the switches are set to the drive state HHH, MMM or LLL, a duration for which the switches are set to the drive state MML or HHM and a duration for which the switches are set to the drive state LML or MHM are calculated.

In the switching control, the modulation unit 55 controls the voltages of the first and second capacitors 21 and 22 so as to keep the voltages of the first and second capacitors 21 and 22 within the predetermined range. For example, the modulation unit 55 may turn on and off the switches SUH to SWL and QU to QW so as to have the first and second capacitors 21 and 22 charged and discharged.

However, there is a concern that the period of variation in the voltages of the first and second capacitors 21 and 22 may become long, causing the controllability of the voltages of the first and second capacitors 21 and 22 to be lowered.

For example, the switching control may be performed so that: in the earlier one of two consecutive switching cycles, the drive states of the switches SUH to SWL and QU to QW transition in the order of HHH→HHM→HMM→MMM; and in the later one of the two consecutive switching cycles, the drive states of the switches SUH to SWL and QU to QW transition in the order of MMM→MML→MLL→LLL. Assuming a situation in which the voltages of the first and second capacitors 21 and 22 are higher than the phase-to-phase voltages, as described above with reference to FIGS. 5 and 6, the direction of electric current flowing through the neutral point O in one of the two drive states HHM and MML is opposite to that in the other of the two drive states HHM and MML; and the direction of electric current flowing through the neutral point O in one of the two drive states HMM and MLL is opposite to that in the other of the two drive states HMM and MLL. Moreover, with the above drive patterns of the switching control, the second capacitor 22 is charged in the earlier switching cycle and discharged in the later switching cycle; and the first capacitor 21 is discharged in the earlier switching cycle and charged in the later switching cycle. That is, during the two consecutive switching cycles, each of the first and second capacitors 21 and 22 is charged and discharged only once. In this case, the number of variations in the voltages of the first and second capacitors 21 and 22 with respect to the number of transitions between different drive states of the switches SUH to SWL and QU to QW is small; consequently, the controllability of the voltages of the first and second capacitors 21 and 22 may be lowered.

In view of the above, in the present embodiment, the modulation unit 55 selects, based on the command voltage vector Vαβ, a drive pattern that is a combination of drive states of the switches SUH to SWL and QU to QW in one switching cycle. More specifically, the modulation unit 55 selects, based on the command voltage vector Vαβ, a drive pattern such that durations for which the switches SUH to SWL and QU to QW are set to specific drive states occur within one switching cycle. Then, the modulation unit 55 performs switching control of the switches SUH to SWL and QU to QW based on the selected drive pattern.

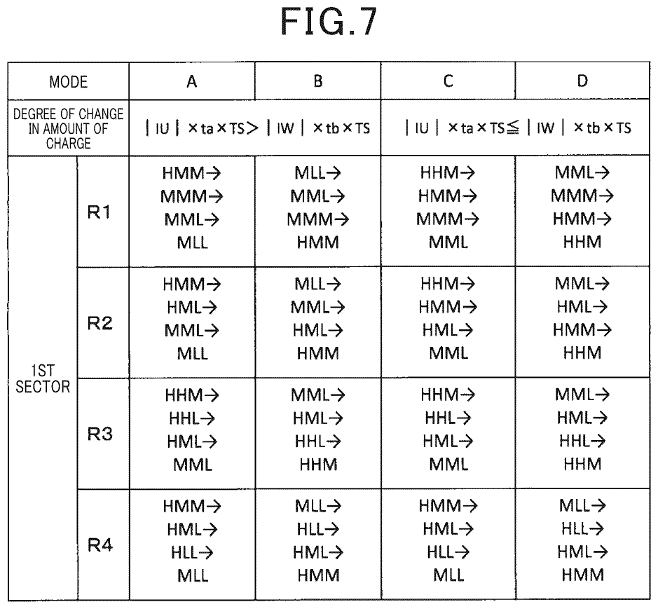

FIG. 7 illustrates an example of drive patterns having the above-described feature and selectable by the modulation unit 55. Hereinafter, explanation will be given taking the first sector as an example. As shown in FIG. 7, the modulation unit 55 can select a drive pattern such that the specific drive states HMM and MLL or the specific drive states HHM and MML occur until transition between different drive states of the switches SUH to SWL and QU to QW is made three times.

In the case of the command voltage vector Vαβ being identified by the modulation unit 55 as existing in the first region R1 of the first sector, the modulation unit 55 turns on and off the switches SUH to SWL and QU to QW in one of drive pattern modes A to D shown in the section for the first region R1 in FIG. 7. Each of the modes A and B corresponding to the first region R1 is a combination of the drive states HMM, MMM, MML and MLL. However, the transition order of the drive states HMM, MMM, MML and MLL in the mode A is different from that in the mode B. Moreover, in each of the modes A and B corresponding to the first region R1, there are a duration for which the switches SUH to SWL and QU to QW are set to one of the two specific drive states HMM and MLL and a duration for which the switches SUH to SWL and QU to QW are set to the other of the two specific drive states HMM and MLL respectively at the beginning and end of one switching cycle. On the other hand, each of the modes C and D corresponding to the first region R1 is a combination of the drive states HHM, HMM, MMM and MML. However, the transition order of the drive states HHM, HMM, MMM and MML in the mode Cis different from that in the mode D. Moreover, in each of the modes C and D corresponding to the first region R1, there are a duration for which the switches SUH to SWL and QU to QW are set to one of the two specific drive states HHM and MML and a duration for which the switches SUH to SWL and QU to QW are set to the other of the two specific drive states HHM and MML respectively at the beginning and end of one switching cycle.

Each of the drive pattern modes A to D in the case of the command voltage vector Vαβ being identified as existing in the first region R1 of the first sector includes the drive state MMM, but neither the drive state HHH nor the drive state LLL. In other words, the modulation unit 55 selects a drive pattern that includes, among the three zero-voltage drive states, only the drive state MMM in which all the phase windings 11U to 11W are connected with the neutral point O.

In the case of the command voltage vector Vαβ being identified by the modulation unit 55 as existing in the second region R2 of the first sector, the modulation unit 55 turns on and off the switches SUH to SWL and QU to QW in one of drive pattern modes A to D shown in the section for the second region R2 in FIG. 7. Each of the modes A and B corresponding to the second region R2 is a combination of the drive states HMM, HML, MML and MLL. However, the transition order of the drive states HMM, HML, MML and MLL in the mode A is different from that in the mode B. Moreover, in each of the modes A and B corresponding to the second region R2, there are a duration for which the switches SUH to SWL and QU to QW are set to one of the two specific drive states HMM and MLL and a duration for which the switches SUH to SWL and QU to QW are set to the other of the two specific drive states HMM and MLL respectively at the beginning and end of one switching cycle. On the other hand, each of the modes C and D corresponding to the second region R2 is a combination of the drive states HHM, HMM, HML and MML. However, the transition order of the drive states HHM, HMM, HML and MML in the mode C is different from that in the mode D. Moreover, in each of the modes C and D corresponding to the second region R2, there are a duration for which the switches SUH to SWL and QU to QW are set to one of the two specific drive states HHM and MML and a duration for which the switches SUH to SWL and QU to QW are set to the other of the two specific drive states HHM and MML respectively at the beginning and end of one switching cycle.

In the case of the command voltage vector Vαβ being identified by the modulation unit 55 as existing in the third region R3 of the first sector, the modulation unit 55 turns on and off the switches SUH to SWL and QU to QW in one of drive pattern modes A to D shown in the section for the third region R3 in FIG. 7. Each of the modes A and B corresponding to the third region R3 is a combination of the drive states HHM, HHL, HML and MML. However, the transition order of the drive states HHM, HHL, HML and MML in the mode A is different from that in the mode B. Moreover, in each of the modes A and B corresponding to the third region R3, there are a duration for which the switches SUH to SWL and QU to QW are set to one of the two specific drive states HHM and MML and a duration for which the switches SUH to SWL and QU to QW are set to the other of the two specific drive states HHM and MML respectively at the beginning and end of one switching cycle. Furthermore, in the third region R3 of the first sector, the mode C is the same drive pattern as the mode A; and the mode D is the same drive pattern as the mode B.

In the case of the command voltage vector Vαβ being identified by the modulation unit 55 as existing in the fourth region R4 of the first sector, the modulation unit 55 turns on and off the switches SUH to SWL and QU to QW in one of drive pattern modes A to D shown in the section for the fourth region R4 in FIG. 7. Each of the modes A and B corresponding to the fourth region R4 is a combination of the drive states HMM, HML, HLL and MLL. However, the transition order of the drive states HMM, HML, HLL and MLL in the mode A is different from that in the mode B. Moreover, in each of the modes A and B corresponding to the fourth region R4, there are a duration for which the switches SUH to SWL and QU to QW are set to one of the two specific drive states HMM and MLL and a duration for which the switches SUH to SWL and QU to QW are set to the other of the two specific drive states HMM and MLL respectively at the beginning and end of one switching cycle. Furthermore, in the fourth region R4 of the first sector, the mode C is the same drive pattern as the mode A; and the mode D is the same drive pattern as the mode B.

When the existence sector and existence region of the command voltage vector Vαβ in the current switching cycle are the same as those in the previous switching cycle, the modulation unit 55 alternately selects the drive pattern modes A and B, or alternately selects the drive pattern modes C and D. In other words, the modulation unit 55 selects the drive pattern for each switching cycle such that: both the first drive state and the last drive state in each switching cycle are specific drive states; and the specific drive state that occurs first in the current switching cycle is identical to the specific drive state that occurs last in the previous switching cycle.

The above-described drive pattern selection process is also applicable to cases where the command voltage vector Vαβ exists in any of the second to sixth sectors. For example, if the above-described drive pattern selection process is applied to the case of the command voltage vector Vαβ existing in the second sector, the drive pattern selected by the modulation unit 55 will be as follows. Of the drive pattern modes corresponding to the first region R1 of the second sector: in a mode A, drive states MML, MMM, MHM and HHM occur in this order; in a mode B, drive states HHM, MHM, MMM and MML occur in this order; in a mode C, drive states LML, MML, MMM and MHM occur in this order; and in a mode D, drive states MHM, MMM, MML and LML occur in this order. Of the drive pattern modes corresponding to the second region R2 of the second sector: in a mode A, drive states MML, MHL, MHM and HHM occur in this order; in a mode B, drive states HHM, MHM, MHL and MML occur in this order; in a mode C, drive states LML, MML, MHL and MHM occur in this order; and in a mode D, drive states MHM, MHL, MML and LML occur in this order.

Of the drive pattern modes corresponding to the third region R3 of the second sector: in a mode A, drive states LML, LHL, MHL and MHM occur in this order; in a mode B, drive states MHM, MHL, LHL and LML occur in this order; a mode C is identical to the mode A; and a mode D is identical to the mode B. Of the drive pattern modes corresponding to the fourth region R4 of the second sector: in a mode A, drive states MML, MHL, HHL and HHM occur in this order; in a mode B, drive states HHM, HHL, MHL and MML occur in this order; a mode C is identical to the mode A; and a mode D is identical to the mode B.

Based on the command voltage vector Vαβ and the phase currents flowing through the respective phase windings 11U to 11W, the modulation unit 55 selects, of two modes of the selected drive pattern, the mode in which the amount of change in the stored charges in the first and second capacitors 21 and 22 caused by specific-phase current, which is electric current flowing through a specific phase, is greater. Here, the specific phase denotes, of the three phases, the phase whose phase voltage level in a specific drive state is different from those of the other phases. Moreover, the specific-phase current denotes the electric current flowing through the specific phase during a duration for which the switches SUH to SWL and QU to QW are set to the specific drive state. In addition, the modulation unit 55 can use the detection values of the phase current sensor 43 as the phase currents flowing through the respective phase windings 11U to 11W.

Specifically, explanation will be given taking the case of the command voltage vector Vαβ being identified as existing in the first region R1 of the first sector as an example. The specific phase during durations for which the switches SUH to SWL and QU to QW are set to the specific drive states HMM and MLL is the U phase; and the specific-phase current is the U-phase current that flows during these durations. On the other hand, the specific phase during durations for which the switches SUH to SWL and QU to QW are set to the specific drive states HHM and MML is the W phase; and the specific-phase current is the W-phase current that flows during these durations. The specific drive states HMM and MLL are drive states used in the modes A and B, whereas the specific drive states HHM and MML are drive states used in the modes C and D. That is, the drive pattern corresponding to the first region R1 of the first sector has two modes (e.g., the modes A and C or the modes B and D) selectable for the same command voltage vector Vαβ and differing in the specific phase during the durations for which the switches SUH to SWL and QU to QW are set to the specific drive states. In this case, the modulation unit 55 compares the amount of change in the stored charges in the first and second capacitors 21 and 22 caused by the U-phase current that flows in the specific drive states HMM and MLL with the amount of change in the stored charges in the first and second capacitors 21 and 22 caused by the W-phase current that flows in the specific drive states HHM and MML.

The amount of change in the stored charges in the first and second capacitors 21 and 22 caused by the U-phase current that flows in the specific drive states HMM and MLL can be expressed by, for example, |IU|×ta×TS. On the other hand, the amount of change in the stored charges in the first and second capacitors 21 and 22 caused by the W-phase current that flows in the specific drive states HHM and MML can be expressed by, for example, |IW|×tb×TS. Here, |IU| and |IW| respectively represent the magnitudes of the U-phase and W-phase currents; and TS represents the length of one switching cycle. Moreover, as described above with reference to FIG. 4, ta and tb are the coefficients by which the voltage vectors representing the specific drive states are multiplied to obtain the voltage vectors V1 and V2. In this case, ta×TS represents the sum of the durations for which the switches SUH to SWL and QU to QW are set to the specific drive states MLL and HMM; and tb×TS represents the sum of the durations for which the switches SUH to SWL and QU to QW are set to the specific drive states MML and HHM.

When it is determined that |IU|×ta×TS>|IW|×tb×TS, the modulation unit 55 selects one of the drive pattern modes A and B. In contrast, when it is determined that |IU|×ta×TS≤|IW|×tb×TS, the modulation unit 55 selects one of the drive pattern modes C and D.

Moreover, in the case of the command voltage vector Vαβ being identified as existing in the second region R2 of the first sector, the modulation unit 55 can also select, based on a comparison between the amounts of changes in the stored charges in the first and second capacitors 21 and 22 caused by different specific-phase currents, one of the drive pattern modes A and B or one of the drive pattern modes C and D. On the other hand, in the case of the command voltage vector Vαβ being identified as existing in one of the third and fourth regions R3 and R4 of the first sector, it is unnecessary for the modulation unit 55 to perform the above-described process because the mode C is the same drive pattern as the mode A and the mode D is the same drive pattern as the mode B in the third and fourth regions R3 and R4.

The above-described drive pattern mode selection process for the switches SUH to SWL and QU to QW is also applicable to cases where the command voltage vector Vαβ exists in any of the second to sixth sectors.

Specifically, in the case of the command voltage vector Vαβ existing in the fourth sector, the drive pattern mode selection process is performed as follows. The specific phase during durations for which the switches SUH to SWL and QU to QW are set to the specific drive states LMM and MHH is the U phase; and the specific-phase current is the U-phase current that flows during these durations. On the other hand, the specific phase during durations for which the switches SUH to SWL and QU to QW are set to the specific drive states LLM and MMH is the W phase; and the specific-phase current is the W-phase current that flows during these durations. In this case, the modulation unit 55 compares the amount of change in the stored charges in the first and second capacitors 21 and 22 caused by the U-phase current that flows in the specific drive states LMM and MHH with the amount of change in the stored charges in the first and second capacitors 21 and 22 caused by the W-phase current that flows in the specific drive states LLM and MMH. Then, the modulation unit 55 selects a drive pattern mode according to the result of the comparison. Specifically, the modulation unit 55 selects whether to have the U-phase-side specific drive states LMM and MHH or the W-phase-side specific drive states LLM and MMH occurring within one switching cycle.

In the case of the command voltage vector Vαβ existing in the second sector or the fifth sector, the drive pattern mode selection process is performed as follows. The specific phase during durations for which the switches SUH to SWL and QU to QW are set to the specific drive states LML and MHM or MLM and HMH is the V phase; and the specific-phase current is the V-phase current that flows during these durations. On the other hand, the specific phase during durations for which the switches SUH to SWL and QU to QW are set to the specific drive states MML and HHM or LLM and MMH is the W phase; and the specific-phase current is the W-phase current that flows during these durations. In this case, the modulation unit 55 compares the amount of change in the stored charges in the first and second capacitors 21 and 22 caused by the V-phase current that flows in the specific drive states LML and MHM or MLM and HMH with the amount of change in the stored charges in the first and second capacitors 21 and 22 caused by the W-phase current that flows in the specific drive states MML and HHM or LLM and MMH. Then, the modulation unit 55 selects a drive pattern mode according to the result of the comparison. Specifically, the modulation unit 55 selects whether to have the V-phase-side specific drive states LML and MHM or MLM and HMH or the W-phase-side specific drive states MML and HHM or LLM and MMH occurring within one switching cycle.

In the case of the command voltage vector Vαβ existing in the third sector or the sixth sector, the drive pattern mode selection process is performed as follows. The modulation unit 55 compares the amount of change in the stored charges in the first and second capacitors 21 and 22 caused by the U-phase current that flows in the specific drive states LMM and MHH or MLL and HMM with the amount of change in the stored charges in the first and second capacitors 21 and 22 caused by the V-phase current that flows in the specific drive states LML and MHM or MLM and HMH. Then, the modulation unit 55 selects a drive pattern mode according to the result of the comparison. Specifically, the modulation unit 55 selects whether to have the U-phase-side specific drive states LMM and MHH or MLL and HMM or the V-phase-side specific drive states LML and MHM or MLM and HMH occurring within one switching cycle.

The modulation unit 55 adjusts, based on an adjustment coefficient k, the ratios of occurrence durations of two different specific drive states included in a drive pattern in one switching cycle to the sum of the occurrence durations of the two different specific drive states. Moreover, the modulation unit 55 adjusts the value of the adjustment coefficient k based on the command voltage vector Vαβ and the voltages of the first and second capacitors 21 and 22. In addition, the modulation unit 55 can use the detection value of the first voltage sensor 41 as the voltage of the first capacitor 21 and the detection value of the second voltage sensor 42 as the voltage of the second capacitor 22.

Specifically, as an example, explanation will be given of the case where the command voltage vector Vαβ is identified as existing in the first region R1 of the first sector and the switches SUH to SWL and QU to QW are driven in the drive pattern mode A. In this case, the modulation unit 55 sets the duration for which the switches SUH to SWL and QU to QW are set to the specific drive state HMM to (1−k)×ta×TS, and sets the duration for which the switches SUH to SWL and QU to QW are set to the specific drive state MLL to k×ta×TS. Moreover, the modulation unit 55 adjusts the value of the adjustment coefficient k (0≤k≤1). In addition, as mentioned above, ta×TS represents the sum of the durations for which the switches SUH to SWL and QU to QW are set to the specific drive states MLL and HMM.

In the present embodiment, the value of the adjustment coefficient k is adjusted so as to reduce the voltage variation amplitude ΔV of the first and second capacitors 21 and 22 in one switching cycle. For example, the voltage variation amplitude ΔV of the first and second capacitors 21 and 22 in one switching cycle can be expressed by the following equation (e1).

$$Δ V = \frac{Qnp + TS \{ {I}_{a} ( 1 - k ) {t}_{a} + {I}_{b} {t}_{b} - {I}_{a} {kt}_{a} \}}{c} \qquad ( e1 )$$

Here, c is the capacitance of the first and second capacitors 21 and 22. Qnp represents the difference between the amount of charge stored in the first capacitor 21 and the amount of charge stored in the second capacitor 22. Moreover, tb×TS represents a duration for which the switches SUH to SWL and QU to QW are set to the drive state MML. Ia represents the electric current flowing through the neutral point O during the durations for which the switches SUH to SWL and QU to QW are set to the drive states MLL and HMM. In addition, Ia=IU. The sign of the U-phase current IU is defined to be positive when the electric current flows in the direction from the neutral point O to the U-phase winding 11U. Ib represents the electric current flowing through the neutral point O during the duration for which the switches SUH to SWL and QU to QW are set to the drive state MML. In addition, Ib=IW. The sign of the W-phase current IW is defined to be positive when the electric current flows in the direction from the neutral point O to the W-phase winding 11W. It should be noted that the difference Qnp between the amount of charge stored in the first capacitor 21 and the amount of charge stored in the second capacitor 22 can be calculated based on the detection values of the first and second voltage sensors 41 and 42.

For example, the modulation unit 55 may adjust the adjustment coefficient k so as to have the voltage variation amplitude ΔV of the first and second capacitors 21 and 22 in one switching cycle become zero. In addition, if ΔV=0 in the above equation (e1), then the adjustment coefficient k can be expressed by the following equation (e2).

$$k = \frac{\frac{Qnp}{TS} + ( {I}_{a} {t}_{a} + {I}_{b} {t}_{b} )}{2 {I}_{a} {t}_{a}} \qquad ( e2 )$$

In addition, in cases where it is impossible to adjust the adjustment coefficient k so as to have the voltage variation amplitude ΔV of the first and second capacitors 21 and 22 in one switching cycle become zero, it is still possible for the modulation unit 55 to adjust the adjustment coefficient k, within a range in which it can be adjusted, so as to minimize the voltage variation amplitude ΔV.

It should be noted that the above-described adjustment process using the adjustment coefficient k is not limited to the case of the command voltage vector Vαβ existing in the first region R1 of the first sector, but can also be applied to cases where the command voltage vector Vαβ exists in the first region R1 of any of the second to sixth sectors. Moreover, it also should be noted that the above-described adjustment process using the adjustment coefficient k can also be applied to cases where the command voltage vector Vαβ exists in any of the second to fourth regions R2 to R4 of the first to sixth sectors. In these cases, it is possible to adjust, by considering the voltage variation amplitude ΔV according to the existence sector and existence region of the command voltage vector Vαβ, the occurrence durations of two different specific drive states that occur within one switching cycle.

FIG. 8 illustrates steps of the control process performed by the control apparatus 40. The control process is repeated at a predetermined cycle.

In step S10, the command torque Trq* inputted from the host control apparatus, the phase currents flowing through the respective phase windings 11U to 11W, the voltages of the first and second capacitors 21 and 22 and the electrical angle of the rotating electric machine 10 are acquired. More particularly, in the present embodiment, the detection values of the phase current sensor 43 are acquired as the phase currents; the detection value of the first voltage sensor 41 is acquired as the voltage of the first capacitor 21; the detection value of the second voltage sensor 42 is acquired as the voltage of the second capacitor 22; and the detection value of the rotation angle sensor 44 is acquired as the electrical angle of the rotating electric machine 10.

The conduction loss caused by electric current flowing through the switches SUH to SWL and QU to QW may be higher in the drive state MMM than in the drive states HHH and LLL. More particularly, in the present embodiment, in the drive state MMM where each of the clamp switches QU to QW is in an ON state, electric current flows through six IGBTs. In contrast, in the drive state HHH where each of the upper-arm switches SUH to SWH is in an ON state and in the drive state LLL where each of the lower-arm switches SUL to SWL is in an ON state, electric current flows through three IGBTs. Therefore, when the switches SUH to SWL and QU to QW are set to the drive state MMM among the three zero-voltage drive states, the conduction loss in the switching control may become higher due to the larger number of the switches through which electric current flows.

In view of the above, in the present embodiment, the mode of the switching control is switched according to the operating point of the rotating electric machine 10.

In step S11, it is determined whether the operating point of the rotating electric machine 10 is within a voltage control region E2. The voltage control region E2 is a region outside a specific region E1 in which the conduction loss caused by electric current flowing through the switches SUH to SWL and QU to QW is higher than or equal to a predetermined allowable value, and is a region in which the voltage variation amplitude of the first and second capacitors 21 and 22 is relatively high. If the result of the determination in step S11 is negative, the control process proceeds to step S17. In contrast, if the result of the determination in step S11 is affirmative, the control process proceeds to step S12.

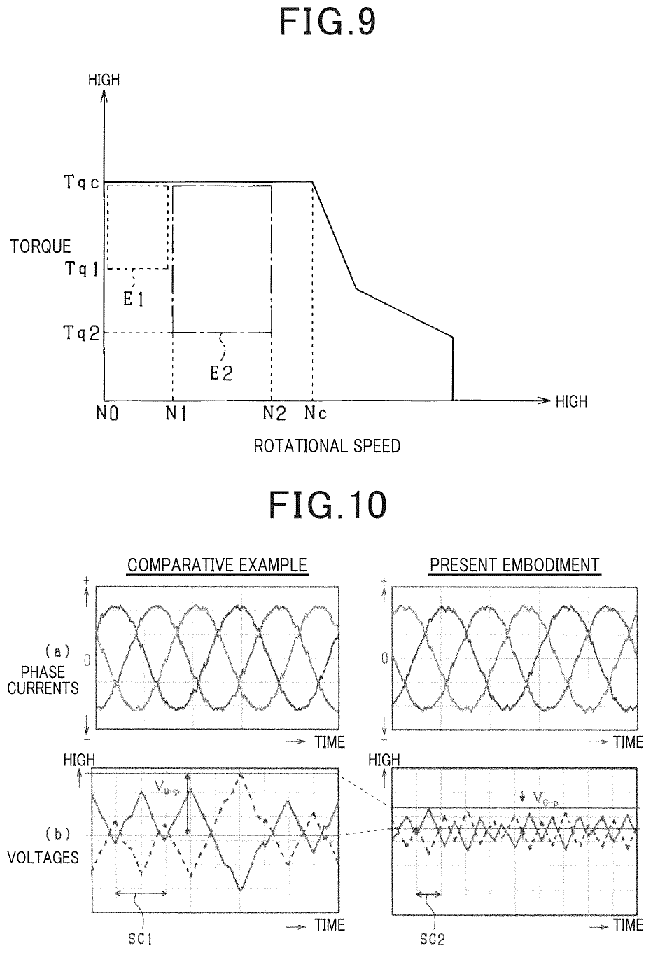

Specifically, as shown in FIG. 9, the operating point of the rotating electric machine 10 is determined by the torque and rotational speed of the rotating electric machine 10. Both the specific region E1 and the voltage control region E2 are regions of the operating point of the rotating electric machine 10. The specific region E1 is a region in which: the torque of the rotating electric machine 10 has a value in the range from a first torque value Tq1 to a maximum torque value Tqc that the rotating electric machine 10 can output; and the rotational speed of the rotating electric machine 10 has a value in the range from a lower limit value N0 set on the lower rotational speed side to a first rotational speed value N1 that is higher than the lower limit value N0. The lower limit value N0 may be set to, for example, 0. That is, the specific region E1 is provided on the side where the modulation factor of the switching control becomes a low modulation factor. In the specific region E1, the conduction loss in the switching control may become high; therefore, it is desirable to shorten the occurrence duration of the drive state MMM of the switches SUH to SWL and QU to QW.

On the other hand, the voltage control region E2 is a region in which: the torque of the rotating electric machine 10 has a value in the range from a second torque value Tq2, which is lower than the first torque value Tq1, to the maximum torque value Tqc; and the rotational speed of the rotating electric machine 10 has a value in the range from the first rotational speed value N1 to a second rotational speed value N2. The second rotational speed value N2 is higher than the first rotational speed value N1 and lower than a predetermined rotational speed value Nc. The predetermined rotational speed value Nc is set on the lower rotational speed side of a region in which the torque that the rotating electric machine 10 can output decreases with increase in the rotational speed of the rotating electric machine 10. In the voltage control region E2, the voltage variation amplitude of the first and second capacitors 21 and 22 may become relatively high; therefore, it is desirable to improve the controllability of the voltages of the first and second capacitors 21 and 22.

In view of the above, in the present embodiment, if it is determined in step S11 that the operating point of the rotating electric machine 10 is within the voltage control region E2, the following steps S12 to S16 are executed. It should be noted that: the command torque can be used as the torque for determining the operating point of the rotating electrical machine 10; and a rotational speed that is calculated based on the detection value of the rotation angle sensor 44 can be used as the rotational speed for determining the operating point of the rotating electrical machine 10. In addition, step S11 corresponds to a “determination unit”.

In step S12, the command voltage vector Vαβ is calculated. In step S13, the sector in which the command voltage vector Vαβ exists and the existence region of the command voltage vector Vαβ within the sector are identified. In addition, in steps S12 and S13, the control apparatus 40 functions as the command current setting unit 50, the two-phase conversion unit 51, the d-axis and q-axis deviation calculation units 52a and 52b, the d-axis and q-axis command voltage calculation units 53a and 53b, the fixed coordinate conversion unit 54 and the modulation unit 55, all of which are described above with reference to FIG. 2.

In step S14, a drive pattern is selected based on the command voltage vector Vαβ and the phase currents. Specifically, based on the command voltage vector Vαβ, a drive pattern is selected such that both a duration for which the switches SUH to SWL and QU to QW are set to one of two different specific drive states and a duration for which the switches SUH to SWL and QU to QW are set to the other of the two different specific drive states occur within one switching cycle. More particularly, in the present embodiment, a drive pattern is selected for each switching cycle such that: both the first drive state and the last drive state in each switching cycle are specific drive states; and the specific drive state that occurs first in the current switching cycle is identical to the specific drive state that occurs last in the previous switching cycle. Moreover, the drive state MMM is selected for the duration for which the switches SUH to SWL and QU to QW are set to a zero-voltage drive state. Furthermore, of two modes of the selected drive pattern, the mode in which the amount of change in the stored charges in the first and second capacitors 21 and 22 caused by the specific-phase current is greater is selected based on the command voltage vector Vαβ and the phase currents. In addition, step S14 corresponds to a “selection unit”.

In step S15, the adjustment coefficient k is calculated. In the present embodiment, the adjustment coefficient k is adjusted so as to have the voltage variation amplitude ΔV of the first and second capacitors 21 and 22 in one switching cycle become zero or a minimum. In addition, step S15 corresponds to an “adjustment unit”.

In step S16, the switching control is performed based on the drive pattern and mode of the switches SUH to SWL and QU to QW determined by the above-described steps S12 to S15.

In step S17, normal control is performed. In the normal control, unlike the drive pattern selection in step S14, it is unnecessary to select a drive pattern such that both a duration for which the switches SUH to SWL and QU to QW are set to one of two different specific drive states and a duration for which the switches SUH to SWL and QU to QW are set to the other of the two different specific drive states occur within one switching cycle. Moreover, in the normal control, in the case of the command voltage vector Vαβ being identified as existing in the first region R1 of any of the first to sixth sectors, it is unnecessary to select a drive pattern such that the zero-voltage drive state of the switches SUH to SWL and QU to QW is limited to MMM among the three zero-voltage drive states. In this case, in the normal control, the switching control is performed so as to shorten, of durations for which the switches SUH to SWL and QU to QW are set to the zero-voltage drive states, the duration for which the switches SUH to SWL and QU to QW are set to the zero-voltage drive state MMM in comparison with the case of the result of the determination in step S11 being affirmative. For example, in the normal control, the drive states of the switches SUH to SWL and QU to QW may transition in the order of HHH→HHM→HMM→MMM or MMM→MML→MLL→LLL in one switching cycle. In addition, steps S16 and S17 correspond to a “switch control unit”.

FIG. 10 shows an example giving comparison between the switching control according to the present embodiment and the switching control according to a comparative example. Specifically, in FIG. 10, (a) illustrates the changes with time of the phase currents, whereas (b) illustrates the changes with time of the voltages of the first and second capacitors 21 and 22. Moreover, in FIG. 10 (b), the solid lines indicate the change with time of the voltage of the first capacitor 21, whereas the dashed lines indicate the change with time of the voltage of the second capacitor 22. It should be noted that the above-described normal control is performed as the switching control according to the comparative example. In addition, in both (a) and (b) of FIG. 10, the scales of the vertical and horizontal axes in the graphs illustrating the switching control according to the present embodiment are the same as those in the graphs illustrating the switching control according to the comparative example.

In the present embodiment, through the execution of steps S12 to S16, the charge/discharge period (i.e., the period of variation in the voltages) of the first and second capacitors 21 and 22 are shortened in comparison those in the comparative example. Consequently, in the present embodiment, the variation amplitude V0-p of the voltages of the first and second capacitors 21 and 22 is reduced in comparison with that in the comparative example. In addition, in FIG. 10 (b), SC1 indicates the charge/discharge period of the first and second capacitors 21 and 22 in the comparative example, whereas SC2 indicates the charge/discharge period of the first and second capacitors 21 and 22 in the present embodiment. In the example shown in FIG. 10, by performing the switching control according to the present embodiment, it becomes possible to shorten the charge/discharge period of the first and second capacitors 21 and 22 to half of that in the comparative example, thereby reducing the variation amplitude V0-p of the voltages of the first and second capacitors 21 and 22 to 40% of that in the comparative example.

According to the present embodiment, it becomes possible to achieve the following advantageous effects.

In the present embodiment, a drive pattern, which is a combination of drive states of the switches SUH to SWL and QU to QW, is selected based on the command voltage vector Vαβ. Specifically, the drive pattern is selected, based on the command voltage vector Vαβ, such that both a duration for which the switches SUH to SWL and QU to QW are set to one of two different specific drive states and a duration for which the switches SUH to SWL and QU to QW are set to the other of the two different specific drive states occur within one switching cycle. Then, the switching control of the switches SUH to SWL and QU to QW is performed based on the selected drive pattern. In this case, the directions of changes in the voltages of the first and second capacitors 21 and 22 during the duration for which the switches SUH to SWL and QU to QW are set to one of the two different specific drive states are opposite to those during the duration for which the switches SUH to SWL and QU to QW are set to the other of the two different specific drive states. Consequently, it becomes possible to have the voltages of the first and second capacitors 21 and 22 varying at shorter intervals and thereby shorten the period of variation in the voltages of the first and second capacitors 21 and 22 in comparison with the case where only the duration for which the switches SUH to SWL and QU to QW are set to either of the two different specific drive states occurs within one switching cycle. As a result, it becomes possible to improve the controllability of the voltages of the first and second capacitors 21 and 22.

In the present embodiment, the ratios of the occurrence durations of the specific drive states included in the drive pattern in one switching cycle to the sum of the occurrence durations of the specific drive states are adjusted based on the adjustment coefficient k. Consequently, it becomes possible to adjust the amounts of changes in the voltages of the first and second capacitors 21 and 22 that change in opposite directions during the duration for which the switches SUH to SWL and QU to QW are set to one of the specific drive states and during the duration for which the switches SUH to SWL and QU to QW are set to the other of the specific drive states. Thus, it becomes possible to properly control the voltages of the first and second capacitors 21 and 22. As a result, it becomes possible to properly improve the controllability of the voltages of the first and second capacitors 21 and 22.

In the present embodiment, of two modes of the selected drive pattern, the mode in which the amount of change in the stored charges in the first and second capacitors 21 and 22 caused by the specific-phase current is greater is selected based on the command voltage vector Vαβ and the phase currents. Then, the switching control is performed based on the selected drive pattern and mode. Consequently, it becomes possible to reduce the amount of variation in the voltages of the first and second capacitors 21 and 22 within one switching cycle in comparison with the case of selecting, of the two modes of the selected drive pattern, the mode in which the amount of change in the stored charges in the first and second capacitors 21 and 22 caused by the specific-phase current is smaller.

In the present embodiment, the drive pattern is selected such that the two different specific drive states occur within one switching cycle until transition between the drive states of the switches SUH to SWL and QU to QW is made three times. Consequently, it becomes possible to increase the number of variations in the voltages of the first and second capacitors 21 and 22 with respect to the number of transitions between different drive states of the switches SUH to SWL and QU to QW in comparison with cases where transition between the drive states of the switches SUH to SWL and QU to QW is made four or more times until the two different specific drive states occur within one switching cycle. As a result, it becomes possible to properly shorten the period of variation in the voltages of the first and second capacitors 21 and 22.

Moreover, in the present embodiment, the drive pattern is selected such that: the first drive state and the last drive state in one switching cycle are two different specific drive states; and the specific drive state of the switches SUH to SWL and QU to QW that occurs first in the current switching cycle is identical to the specific drive state of the switches SUH to SWL and QU to QW that occurs last in the previous switching cycle. Consequently, it becomes possible to prevent unnecessary switching from being performed between successive switching cycles. As a result, it becomes possible to realize switching control suitable for reducing switching loss.

In the first region R1 of any of the first to sixth sectors, the switches SUH to SWL and QU to QW may be set to a zero-voltage drive state. In this case, the switches SUH to SWL and QU to QW is set to the zero-voltage drive state during the transition from the first specific drive state to the last specific drive state in one switching cycle. At this time, it is desirable to suppress unnecessary switching.

In this regard, in the present embodiment, each of the drive patterns corresponding to the first region R1 of any of the first to sixth sectors is determined to include the zero-voltage drive state MMM among the three zero-voltage drive states. Consequently, it becomes possible to more reliably prevent unnecessary switching from being performed within one switching cycle, in comparison with the case of the switches SUH to SWL and QU to QW being set to the zero-voltage drive state HHH or the zero-voltage drive state LLL. As a result, it becomes possible to realize switching control suitable for reducing switching loss.

In the present embodiment, it is determined whether the operating point of the rotating electric machine 10 is within the voltage control region E2. Moreover, when it is determined that the operating point of the rotating electric machine 10 is within the voltage control region E2, the switching control is performed to improve the controllability of the voltages of the first and second capacitors 21 and 22 and to set the switches SUH to SWL and QU to QW to the zero-voltage drive state MMM among the three zero-voltage drive states. In contrast, when it is determined that the operating point of the rotating electric machine 10 is outside the voltage control region E2, the normal control is performed.

In the normal control, the switches SUH to SWL and QU to QW can be set not only to the zero-voltage drive state MMM, but also to the zero-voltage drive states HHH and LLL. In this case, the duration for which the switches SUH to SWL and QU to QW are set the zero-voltage drive state MMM can be shortened in comparison with the case of the operating point of the rotating electric machine 10 being within the voltage control region E2. Consequently, in situations where the conduction loss in the switching control may become high, it is possible to reduce the conduction loss during the duration for which the switches SUH to SWL and QU to QW are set the zero-voltage drive state MMM. As a result, it is possible to improve the controllability of the voltages of the first and second capacitors 21 and 22 while suppressing increase in the conduction loss in the switching control.

### Second Embodiment

Hereinafter, a second embodiment will be described with reference to the drawings, focusing on the differences thereof from the first embodiment. In the present embodiment, the configuration of the inverter 30 is changed compared to that in the first embodiment.

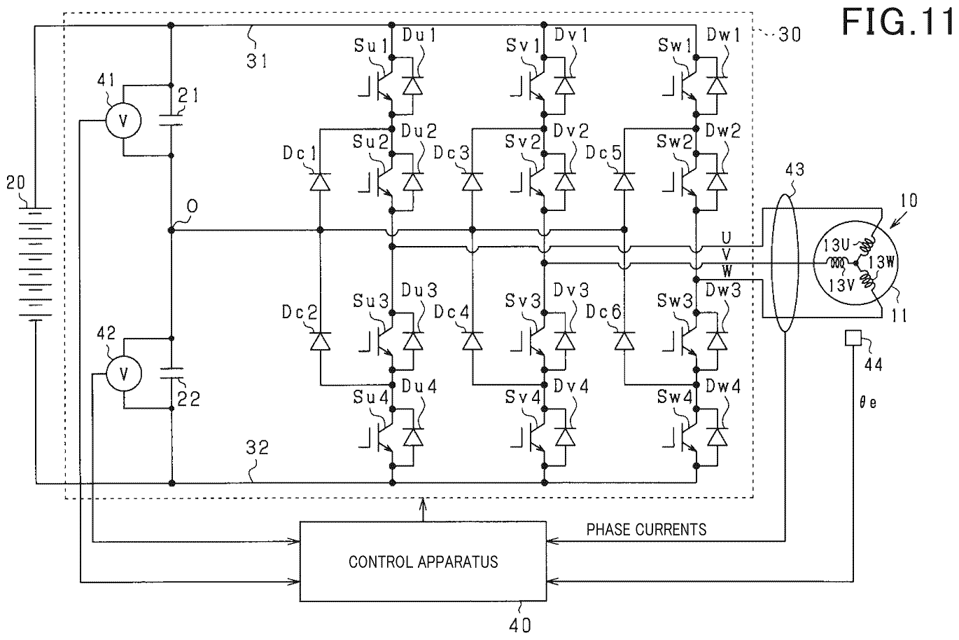

As shown in FIG. 11, in the present embodiment, the inverter 30 is configured as a neutral-point-clamped three-level inverter. Specifically, the inverter 30 includes first to fourth U-phase switches Su1 to Su4, first to fourth V-phase switches Sv1 to Sv4, first to fourth W-phase switches Sw1 to Sw4, and first to sixth clamp diodes Dc1 to Dc6. In the present embodiment, each of the switches Su1 to Su4, Sv1 to Sv4 and Sw1 to Sw4 is implemented by a voltage-controlled semiconductor switching element, more particularly by an IGBT. Therefore, each of the switches Su1 to Su4, Sv1 to Sv4 and Sw1 to Sw4 has its higher-potential-side terminal serving as a collector and its lower-potential-side terminal serving as an emitter. It should be noted that for the sake of convenience, in FIG. 11, components identical to those shown in FIG. 1 are designated by the same reference signs as those shown in FIG. 1.

The first to fourth U-phase switches Su1 to Su4 are connected in series with each other such that each corresponding pair of the emitters and collectors of these switches are connected with each other. Moreover, the collector of the first U-phase switch Su1 is connected with the positive electrode terminal of the battery 20 via the positive-electrode-side bus 31; and the emitter of the fourth U-phase switch Su4 is connected with the negative electrode terminal of the battery 20 via the negative-electrode-side bus 32. Furthermore, to a junction point between the second U-phase switch Su2 and the third U-phase switch Su3, there is connected a U-phase input terminal of the rotating electrical machine 10. To a junction point between the first U-phase switch Su1 and the second U-phase switch Su2, there is connected the cathode of the first clamp diode Dc1. To the anode of the first clamp diode Dc1, there is connected the cathode of the second clamp diode Dc2. To the anode of the second clamp diode Dc2, there is connected a junction point between the third U-phase switch Su3 and the fourth U-phase switch Su4. In addition, each of the U-phase switches Su1, Su2, Su3 and Su4 has a corresponding one of freewheel diodes Du1, Du2, Du3 and Du4 connected in antiparallel thereto.

The first to fourth V-phase switches Sv1 to Sv4 are connected in series with each other such that each corresponding pair of the emitters and collectors of these switches are connected with each other. Moreover, the collector of the first V-phase switch Sv1 is connected with the positive electrode terminal of the battery 20 via the positive-electrode-side bus 31; and the emitter of the fourth V-phase switch Sv4 is connected with the negative electrode terminal of the battery 20 via the negative-electrode-side bus 32. Furthermore, to a junction point between the second V-phase switch Sv2 and the third V-phase switch Sv3, there is connected a V-phase input terminal of the rotating electrical machine 10. To a junction point between the first V-phase switch Sv1 and the second V-phase switch Sv2, there is connected the cathode of the third clamp diode Dc3. To the anode of the third clamp diode Dc3, there is connected the cathode of the fourth clamp diode Dc4. To the anode of the fourth clamp diode Dc4, there is connected a junction point between the third V-phase switch Sv3 and the fourth V-phase switch Sv4. In addition, each of the V-phase switches Sv1, Sv2, Sv3 and Sv4 has a corresponding one of freewheel diodes Dv1, Dv2, Dv3 and Dv4 connected in antiparallel thereto.

The first to fourth W-phase switches Sw1 to Sw4 are connected in series with each other such that each corresponding pair of the emitters and collectors of these switches are connected with each other. Moreover, the collector of the first W-phase switch Sw1 is connected with the positive electrode terminal of the battery 20 via the positive-electrode-side bus 31; and the emitter of the fourth W-phase switch Sw4 is connected with the negative electrode terminal of the battery 20 via the negative-electrode-side bus 32. Furthermore, to a junction point between the second W-phase switch Sw2 and the third W-phase switch Sw3, there is connected a W-phase input terminal of the rotating electrical machine 10. To a junction point between the first W-phase switch Sw1 and the second W-phase switch Sw2, there is connected the cathode of the fifth clamp diode Dc5. To the anode of the fifth clamp diode Dc5, there is connected the cathode of the sixth clamp diode Dc6. To the anode of the sixth clamp diode Dc6, there is connected a junction point between the third W-phase switch Sw3 and the fourth W-phase switch Sw4. In addition, each of the W-phase switches Sw1, Sw2, Sw3 and Sw4 has a corresponding one of freewheel diodes Dw1, Dw2, Dw3 and Dw4 connected in antiparallel thereto.

The neutral point O is connected with a junction point between the first clamp diode Dc1 and the second clamp diode Dc2, a junction point between the third clamp diode Dc3 and the fourth clamp diode Dc4 and a junction point between the fifth clamp diode Dc5 and the sixth clamp diode Dc6.

In the neutral-point-clamped three-level inverter 30 according to the present embodiment, drive states of the switches Su1 to Sw4 are defined as follows. Each phase voltage of a level H is a voltage of the subject phase which is outputted when the first and second switches Su1 and Su2, Sv1 and Sv2 or Sw1 and Sw2 are in an ON state and the third and fourth switches Su3 and Su4, Sv3 and Sv4 or Sw3 and Sw4 are in an OFF state. Each phase voltage of a level M is a voltage of the subject phase which is outputted when the second and third switches Su2 and Su3, Sv2 and Sv3 or Sw2 and Sw3 are in an ON state and the first and fourth switches Su1 and Su4, Sv1 and Sv4 or Sw1 and Sw4 are in an OFF state. Each phase voltage of a level L is a voltage of the subject phase which is outputted when the third and fourth switches Su3 and Su4, Sv3 and Sv4 or Sw3 and Sw4 are in an ON state and the first and second switches Su1 and Su2, Sv1 and Sv2 or Sw1 and Sw2 are in an OFF state.

For example, during the duration for which the switches Su1 to Sw4 are set to the drive state HML, the first and second U-phase switches Su1 and Su2, the second and third V-phase switches Sv2 and Sv3 and the third and fourth W-phase switches Sw3 and Sw4 are in the ON state, whereas the third and fourth U-phase switches Su3 and Su4, the first and fourth V-phase switches Sv1 and Sv4 and the first and second W-phase switches Sw1 and Sw2 are in the OFF state.

The control process which includes steps S10 to S17 shown in FIG. 8 can be performed by the control apparatus 40 also for the neutral-point-clamped three-level inverter 30 according to the present embodiment.

Moreover, in the neutral-point-clamped three-level inverter 30, when the switches Su1 to Sw4 are in the drive state MMM, six IGBTs are in an ON state and six clamp diodes are in a conducting state. In contrast, when the switches Su1 to Sw4 are in the drive state HHH or LLL, only six IGBTs are in an ON state. Therefore, in the present embodiment, depending on the conduction loss of the clamp diodes, the conduction loss in the switching control may become high during a duration for which the switches Su1 to Sw4 are set to the drive state MMM among the three zero-voltage drive states. Hence, by switching the mode of the switching control based on the drive state of the rotating electric machine 10 in step S11 of the control process shown in FIG. 8, it is possible to improve the controllability of the voltages of the first and second capacitors 21 and 22 while suppressing increase in the conduction loss in the switching control.

### Other Embodiments

The above-described embodiments may be modified and implemented as follows.

The modulation unit 55 may adjust, based on at least one of the voltages of the first and second capacitors 21 and 22 instead of the adjustment coefficient k, the ratios of occurrence durations of specific drive states included in a drive pattern to the sum of the occurrence durations of the specific drive states. For example, in the case where the command voltage vector Vαβ is identified as existing in the first region R1 of the first sector and the switches SUH to SWL and QU to QW are driven in the drive pattern mode A, the modulation unit 55 may lengthen the duration for which the switches SUH to SWL and QU to QW are set to the drive state HMM and shorten the duration for which the switches SUH to SWL and QU to QW are set to the drive state MLL with increase in the detected voltage of the first capacitor 21. Moreover, in this case, the modulation unit 55 may lengthen the duration for which the switches SUH to SWL and QU to QW are set to the drive state MLL and shorten the duration for which the switches SUH to SWL and QU to QW are set to the drive state HMM with increase in the detected voltage of the second capacitor 22.

With the above configuration, it is also possible to adjust the ratio between the durations for which the switches SUH to SWL and QU to QW are driven in two different specific drive states, thereby properly controlling the voltages of the first and second capacitors 21 and 22.

In step S17 of the control process shown in FIG. 8, a drive pattern may alternatively be selected as in step S14. However, in this case, in step S17, it is necessary to select a drive pattern such that during a duration for which the switches SUH to SWL and QU to QW are set to a zero-voltage drive state, the zero-voltage drive state is the drive state HHH or LLL. Consequently, it will become possible to shorten a duration for which the switches SUH to SWL and QU to QW are set to the drive state MMM in comparison with the case of using the drive pattern selected in step S14.

In step S11 of the control process shown in FIG. 8, instead of the determination as to whether the operating point of the rotating electric machine 10 is within the voltage control region E2, a determination may be made as to whether the operating point of the rotating electric machine 10 is within the specific region E1. In this case, if the result of the determination in step S11 is negative, the control process proceeds to step S12. In contrast, if the result of the determination in step S11 is affirmative, the control process proceeds to step S17.

Moreover, steps S11 and S17 of the control process shown in FIG. 8 may be omitted. That is, steps S12 to S16 may be executed without switching the mode of the switching control according to the operating point of the rotating electric machine 10.

The semiconductor switching elements constituting the inverter are not limited to IGBTs, but may alternatively be, for example, N-channel MOSFETs. In this case, each of the switches has its higher-potential-side terminal serving as a drain and its lower-potential-side terminal serving as a source. Moreover, in this case, each of the switches has a corresponding body diode.

The power storage units connected to the inverter 30 are not limited to the first and second capacitors 21 and 22, but may alternatively be, for example, chargeable/dischargeable storage batteries.

The connection between the phase windings 11U to 11W of the rotating electric machine 10 is not limited to the star connection, but may alternatively be a delta connection.

The object in which the inverter 30, the rotating electric machine 10 and the control apparatus 40 are installed is not limited to a vehicle, but may alternatively be other mobile objects such as an aircraft or a ship. In the case of the object being an aircraft, the rotating electric machine 10 serves as a flight power source of the aircraft. Otherwise, in the case of the object being a ship, the rotating electric machine 10 serves as a navigation power source of the ship. Furthermore, the object in which the inverter 30, the rotating electric machine 10 and the control apparatus 40 are installed is not limited to mobile objects.

The control units and the control methods described in the present disclosure may be realized by a dedicated computer that includes a processor, which is programmed to perform one or more functions embodied by a computer program, and a memory. As an alternative, the control units and the control methods described in the present disclosure may be realized by a dedicated computer that includes a processor configured with one or more dedicated hardware logic circuits. As another alternative, the control units and the control methods described in the present disclosure may be realized by one or more dedicated computers configured with a combination of a processor programmed to perform one or more functions, a memory and a processor configured with one or more dedicated hardware logic circuits. In addition, the computer program may be stored as computer-executable instructions in a computer-readable non-transitory tangible recording medium.

Hereinafter, characteristic configurations derived from the above-described embodiments will be described.

### First Configuration

A control apparatus (40) for a three-level inverter (30), the control apparatus being applicable to a system comprising:
a first power storage unit (21) and a second power storage unit (22) that are connected in series with each other;
a rotating electric machine (10) having three windings (11U to 11W) respectively corresponding to three phases; and
the three-level inverter having switches (SUH to SWL, QU to QW, Su1 to Sw4) each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control apparatus comprising:
a selection unit configured to select, based on a command voltage for controlling a controlled variable of the rotating electric machine to a command value, a drive pattern that is a combination of drive states of the switches in a switching cycle; and
a switch control unit configured to perform switching control of the switches based on the selected drive pattern,
wherein:
two different ones of the drive states of the switches are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states; and
the selection unit is further configured to select, based on the command voltage, the drive pattern such that both a duration for which the switches are set to one of the specific drive states and a duration for which the switches are set to the other of the specific drive states occur within the switching cycle.

### Second Configuration

The control apparatus according to the first configuration, further comprising an adjustment unit configured to adjust, based on at least one of a voltage of the first power storage unit and a voltage of the second power storage unit, the ratios of the occurrence durations of the specific drive states included in the drive pattern in the switching cycle to the sum of the occurrence durations of the specific drive states.

### Third Configuration

The control apparatus according to the first or second configuration, wherein:
of the three phases, the phase whose connection location between the winding and one of the positive electrode side of the first power storage unit, the neutral point and the negative electrode side of the second power storage unit is different from those of the other phases in each of the specific drive states is defined as a specific phase;
the drive pattern has two modes selectable for the same command voltage and differing in the specific phase during the durations for which the switches are set to the specific drive states;
electric current flowing through the specific phase during the durations for which the switches are set to the specific drive states is defined as specific-phase current; and
the selection unit is further configured to select, based on the command voltage and the electric currents flowing through the windings of the respective phases, that one of the two modes of the selected drive pattern in which the amount of change in stored charges in the first and second power storage units caused by the specific-phase current is greater.

### Fourth Configuration

The control apparatus according to any one of the first to third configurations, wherein the selection unit is further configured to select the drive pattern such that each of the specific drive states occurs until transition between the drive states is made three times.

### Fifth Configuration

The control apparatus according to any one of the first to fourth configurations, wherein the selection unit is further configured to select the drive pattern such that: a first one of the drive states and a last one of the drive states in the switching cycle are the specific drive states; and the specific drive state that occurs first in the switching cycle is identical to a specific drive state that occurs last in a previous switching cycle.

### Sixth Configuration

The control apparatus according to the fifth configuration, wherein:
three drive states of the switches, in each of which all the windings of the respective phases are connected with the positive electrode side of the first power storage unit, with the neutral point or with the negative electrode side of the second power storage unit, are defined as zero-voltage drive states; and
the selection unit is further configured to select the drive pattern to include, among the three zero-voltage drive states, the zero-voltage drive state in which all the windings of the respective phases are connected with the neutral point.

### Seventh Configuration

The control apparatus according to the sixth configuration, wherein:
the three-level inverter is configured so that conduction loss caused by electric current flowing through the switches is higher when all the windings of the respective phases are connected with the neutral point by the switches than when all the windings of the respective phases are connected with the positive electrode side of the first power storage unit or with the negative electrode side of the second power storage unit by the switches;
the control apparatus further comprises a determination unit configured to determine whether an operating point of the rotating electric machine is within a specific region in which the conduction loss caused by the electric current flowing through the switches is higher than or equal to a predetermined allowable value; and
the switch control unit is further configured to perform the switching control so as to shorten, when it is determined that the operating point is within the specific region, a duration for which the switches are set to the zero-voltage drive state in which all the windings of the respective phases are connected with the neutral point than when it is determined that the operating point is outside the specific region.

While the present disclosure has been described pursuant to the above-described embodiments, it should be appreciated that the present disclosure is not limited to these embodiments and the structures. Instead, the present disclosure encompasses various modifications and changes within equivalent ranges. In addition, various combinations and modes are also included in the category and the scope of technical idea of the present disclosure.

What is claimed is:

1. A control apparatus for a three-level inverter, the control apparatus being applicable to a system comprising:
a first power storage unit and a second power storage unit that are connected in series with each other;
a rotating electric machine having three windings respectively corresponding to three phases; and
the three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control apparatus comprising:
a selection unit configured to select, based on a command voltage vector for controlling a controlled variable of the rotating electric machine to a command value, a drive pattern that is a combination of drive states of the switches in a switching cycle; and
a switch control unit configured to perform switching control of the switches based on the selected drive pattern,
wherein:
a vector space in which the command voltage vector exists is divided into six sectors in connection with an argument of the command voltage vector;
each of the sectors includes a first region and a second region;
in each of the sectors,
an endpoint of the sector on one of axes of two phases demarcating the sector which represents a smaller argument is defined as a first endpoint,
an endpoint of the sector on the other of the axes of the two phases which represents a larger argument is defined as a second endpoint,
a midpoint between an origin of the vector space and the first endpoint is defined as a first midpoint,
a midpoint between the origin of the vector space and the second endpoint is defined as a second midpoint,
a midpoint between the first endpoint and the second endpoint is defined as a middle endpoint,
the first region is a region surrounded by a triangle whose vertices are the origin of the vector space, the first midpoint and the second midpoint, and
the second region is a region surrounded by a triangle whose vertices are the first midpoint, the second midpoint and the middle endpoint;
two different ones of the drive states of the switches, in both of which voltages of the respective phases at the first midpoint or the second midpoint are outputted, are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states; and
the selection unit is further configured to
select, when the command voltage vector exists in the first region of any of the sectors, the drive pattern, which is the combination of the drive states of the switches for outputting the voltages of the respective phases at the origin of the vector space, the first midpoint and the second midpoint, such that both a duration for which the switches are set to one of the specific drive states and a duration for which the switches are set to the other of the specific drive states occur within the switching cycle, and
select, when the command voltage vector exists in the second region of any of the sectors, the drive pattern, which is the combination of the drive states of the switches for outputting the voltages of the respective phases at the first midpoint, the second midpoint and the middle endpoint, such that both a duration for which the switches are set to one of the specific drive states and a duration for which the switches are set to the other of the specific drive states occur within the switching cycle.

2. The control apparatus as set forth in claim 1, further comprising an adjustment unit configured to adjust, based on at least one of a voltage of the first power storage unit and a voltage of the second power storage unit, the ratios of the occurrence durations of the specific drive states included in the drive pattern in the switching cycle to the sum of the occurrence durations of the specific drive states.

3. The control apparatus as set forth in claim 1, wherein the selection unit is further configured to select the drive pattern such that each of the specific drive states occurs until transition between the drive states is made three times.

4. The control apparatus as set forth in claim 1, wherein the selection unit is further configured to select the drive pattern such that: a first one of the drive states and a last one of the drive states in the switching cycle are the specific drive states; and the specific drive state that occurs first in the switching cycle is identical to a specific drive state that occurs last in a previous switching cycle.

5. The control apparatus as set forth in claim 4, wherein:
three drive states of the switches, in each of which all the windings of the respective phases are connected with the positive electrode side of the first power storage unit, with the neutral point or with the negative electrode side of the second power storage unit, are defined as zero-voltage drive states; and
the selection unit is further configured to select the drive pattern to include, among the three zero-voltage drive states, the zero-voltage drive state in which all the windings of the respective phases are connected with the neutral point.

6. The control apparatus as set forth in claim 5, wherein:
the three-level inverter is configured so that conduction loss caused by electric current flowing through the switches is higher when all the windings of the respective phases are connected with the neutral point by the switches than when all the windings of the respective phases are connected with the positive electrode side of the first power storage unit or with the negative electrode side of the second power storage unit by the switches;
the control apparatus further comprises a determination unit configured to determine whether an operating point of the rotating electric machine is within a specific region in which the conduction loss caused by the electric current flowing through the switches is higher than or equal to a predetermined allowable value; and
the switch control unit is further configured to perform the switching control so as to shorten, when it is determined that the operating point is within the specific region, a duration for which the switches are set to the zero-voltage drive state in which all the windings of the respective phases are connected with the neutral point than when it is determined that the operating point is outside the specific region.

7. A control apparatus for a three-level inverter, the control apparatus being applicable to a system comprising:
a first power storage unit and a second power storage unit that are connected in series with each other;
a rotating electric machine having three windings respectively corresponding to three phases; and
the three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control apparatus comprising:
a selection unit configured to select, based on a command voltage for controlling a controlled variable of the rotating electric machine to a command value, a drive pattern that is a combination of drive states of the switches in a switching cycle; and
a switch control unit configured to perform switching control of the switches based on the selected drive pattern,
wherein:
two different ones of the drive states of the switches are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states;
of the three phases, the phase whose connection location between the winding and one of the positive electrode side of the first power storage unit, the neutral point and the negative electrode side of the second power storage unit is different from those of the other phases in each of the specific drive states is defined as a specific phase;
the drive pattern has two modes selectable for the same command voltage and differing in the specific phase during the durations for which the switches are set to the specific drive states;
electric current flowing through the specific phase during the durations for which the switches are set to the specific drive states is defined as specific-phase current; and
the selection unit is further configured to
select, based on the command voltage, the drive pattern such that both a duration for which the switches are set to one of the specific drive states and a duration for which the switches are set to the other of the specific drive states occur within the switching cycle, and
select, based on the command voltage and the electric currents flowing through the windings of the respective phases, that one of the two modes of the selected drive pattern in which the amount of change in stored charges in the first and second power storage units caused by the specific-phase current is greater.

8. The control apparatus as set forth in claim 7, further comprising an adjustment unit configured to adjust, based on at least one of a voltage of the first power storage unit and a voltage of the second power storage unit, the ratios of the occurrence durations of the specific drive states included in the drive pattern in the switching cycle to the sum of the occurrence durations of the specific drive states.

9. The control apparatus as set forth in claim 7, wherein the selection unit is further configured to select the drive pattern such that each of the specific drive states occurs until transition between the drive states is made three times.

10. The control apparatus as set forth in claim 7, wherein the selection unit is further configured to select the drive pattern such that: a first one of the drive states and a last one of the drive states in the switching cycle are the specific drive states; and the specific drive state that occurs first in the switching cycle is identical to a specific drive state that occurs last in a previous switching cycle.

11. The control apparatus as set forth in claim 10, wherein:
three drive states of the switches, in each of which all the windings of the respective phases are connected with the positive electrode side of the first power storage unit, with the neutral point or with the negative electrode side of the second power storage unit, are defined as zero-voltage drive states; and
the selection unit is further configured to select the drive pattern to include, among the three zero-voltage drive states, the zero-voltage drive state in which all the windings of the respective phases are connected with the neutral point.

12. The control apparatus as set forth in claim 11, wherein:
the three-level inverter is configured so that conduction loss caused by electric current flowing through the switches is higher when all the windings of the respective phases are connected with the neutral point by the switches than when all the windings of the respective phases are connected with the positive electrode side of the first power storage unit or with the negative electrode side of the second power storage unit by the switches;
the control apparatus further comprises a determination unit configured to determine whether an operating point of the rotating electric machine is within a specific region in which the conduction loss caused by the electric current flowing through the switches is higher than or equal to a predetermined allowable value; and
the switch control unit is further configured to perform the switching control so as to shorten, when it is determined that the operating point is within the specific region, a duration for which the switches are set to the zero-voltage drive state in which all the windings of the respective phases are connected with the neutral point than when it is determined that the operating point is outside the specific region.

13. A non-transitory tangible storage medium storing a program executable by a computer and applicable to a system comprising:
a first power storage unit and a second power storage unit that are connected in series with each other;
a rotating electric machine having three windings respectively corresponding to three phases; and
a three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the program being configured to cause the computer to execute a process comprising:
a selection step of selecting, based on a command voltage vector for controlling a controlled variable of the rotating electric machine to a command value, a drive pattern that is a combination of drive states of the switches in a switching cycle; and
a control step of performing switching control of the switches based on the selected drive pattern,
wherein:
a vector space in which the command voltage vector exists is divided into six sectors in connection with an argument of the command voltage vector;
each of the sectors includes a first region and a second region;
in each of the sectors,
an endpoint of the sector on one of axes of two phases demarcating the sector which represents a smaller argument is defined as a first endpoint,
an endpoint of the sector on the other of the axes of the two phases which represents a larger argument is defined as a second endpoint,
a midpoint between an origin of the vector space and the first endpoint is defined as a first midpoint,
a midpoint between the origin of the vector space and the second endpoint is defined as a second midpoint,
a midpoint between the first endpoint and the second endpoint is defined as a middle endpoint,
the first region is a region surrounded by a triangle whose vertices are the origin of the vector space, the first midpoint and the second midpoint, and
the second region is a region surrounded by a triangle whose vertices are the first midpoint, the second midpoint and the middle endpoint;
two different ones of the drive states of the switches, in both of which voltages of the respective phases at the first midpoint or the second midpoint are outputted, are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states; and
in the selection step,
when the command voltage vector exists in the first region of any of the sectors, the drive pattern, which is the combination of the drive states of the switches for outputting the voltages of the respective phases at the origin of the vector space, the first midpoint and the second midpoint, is selected such that both a duration for which the switches are set to one of the specific drive states and a duration for which the switches are set to the other of the specific drive states occur within the switching cycle, and
when the command voltage vector exists in the second region of any of the sectors, the drive pattern, which is the combination of the drive states of the switches for outputting the voltages of the respective phases at the first midpoint, the second midpoint and the middle endpoint, is selected such that both a duration for which the switches are set to one of the specific drive states and a duration for which the switches are set to the other of the specific drive states occur within the switching cycle.

14. A non-transitory tangible storage medium storing a program executable by a computer and applicable to a system comprising:
a first power storage unit and a second power storage unit that are connected in series with each other;
a rotating electric machine having three windings respectively corresponding to three phases; and
a three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the program being configured to cause the computer to execute a process comprising:
a selection step of selecting, based on a command voltage for controlling a controlled variable of the rotating electric machine to a command value, a drive pattern that is a combination of drive states of the switches in a switching cycle; and
a control step of performing switching control of the switches based on the selected drive pattern,
wherein:
two different ones of the drive states of the switches are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states;
of the three phases, the phase whose connection location between the winding and one of the positive electrode side of the first power storage unit, the neutral point and the negative electrode side of the second power storage unit is different from those of the other phases in each of the specific drive states is defined as a specific phase;
the drive pattern has two modes selectable for the same command voltage and differing in the specific phase during the durations for which the switches are set to the specific drive states;
electric current flowing through the specific phase during the durations for which the switches are set to the specific drive states is defined as specific-phase current; and
in the selection step,
the drive pattern is selected, based on the command voltage, such that both a duration for which the switches are set to one of the specific drive states and a duration for which the switches are set to the other of the specific drive states occur within the switching cycle, and
that one of the two modes of the selected drive pattern in which the amount of change in stored charges in the first and second power storage units caused by the specific-phase current is greater is selected based on the command voltage and the electric currents flowing through the windings of the respective phases.

15. A control method for a three-level inverter, the control method being applicable to a system comprising:
a first power storage unit and a second power storage unit that are connected in series with each other;
a rotating electric machine having three windings respectively corresponding to three phases; and
the three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control method comprising:
a selection step of selecting, based on a command voltage vector for controlling a controlled variable of the rotating electric machine to a command value, a drive pattern that is a combination of drive states of the switches in a switching cycle; and
a control step of performing switching control of the switches based on the selected drive pattern,
wherein:
a vector space in which the command voltage vector exists is divided into six sectors in connection with an argument of the command voltage vector;
each of the sectors includes a first region and a second region;
in each of the sectors,
an endpoint of the sector on one of axes of two phases demarcating the sector which represents a smaller argument is defined as a first endpoint,
an endpoint of the sector on the other of the axes of the two phases which represents a larger argument is defined as a second endpoint,
a midpoint between an origin of the vector space and the first endpoint is defined as a first midpoint,
a midpoint between the origin of the vector space and the second endpoint is defined as a second midpoint,
a midpoint between the first endpoint and the second endpoint is defined as a middle endpoint,
the first region is a region surrounded by a triangle whose vertices are the origin of the vector space, the first midpoint and the second midpoint, and
the second region is a region surrounded by a triangle whose vertices are the first midpoint, the second midpoint and the middle endpoint;
two different ones of the drive states of the switches, in both of which voltages of the respective phases at the first midpoint or the second midpoint are outputted, are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states; and
in the selection step,
when the command voltage vector exists in the first region of any of the sectors, the drive pattern, which is the combination of the drive states of the switches for outputting the voltages of the respective phases at the origin of the vector space, the first midpoint and the second midpoint, is selected such that both a duration for which the switches are set to one of the specific drive states and a duration for which the switches are set to the other of the specific drive states occur within the switching cycle, and
when the command voltage vector exists in the second region of any of the sectors, the drive pattern, which is the combination of the drive states of the switches for outputting the voltages of the respective phases at the first midpoint, the second midpoint and the middle endpoint, is selected such that both a duration for which the switches are set to one of the specific drive states and a duration for which the switches are set to the other of the specific drive states occur within the switching cycle.

16. A control method for a three-level inverter, the control method being applicable to a system comprising:
a first power storage unit and a second power storage unit that are connected in series with each other;
a rotating electric machine having three windings respectively corresponding to three phases; and
the three-level inverter having switches each corresponding to one of the three phases and connecting the winding of the corresponding phase in the rotating electric machine to one of a positive electrode side of the first power storage unit, a neutral point between a negative electrode side of the first power storage unit and a positive electrode side of the second power storage unit, and a negative electrode side of the second power storage unit,
the control method comprising:
a selection step of selecting, based on a command voltage for controlling a controlled variable of the rotating electric machine to a command value, a drive pattern that is a combination of drive states of the switches in a switching cycle; and
a control step of performing switching control of the switches based on the selected drive pattern,
wherein:
two different ones of the drive states of the switches are defined as specific drive states such that (i) three line-to-line voltages between the windings of the rotating electric machine in one of the specific drive states are equal to those in the other of the specific drive states, and (ii) a direction of electric current flowing through the neutral point in one of the specific drive states is opposite to that in the other of the specific drive states;
of the three phases, the phase whose connection location between the winding and one of the positive electrode side of the first power storage unit, the neutral point and the negative electrode side of the second power storage unit is different from those of the other phases in each of the specific drive states is defined as a specific phase;
the drive pattern has two modes selectable for the same command voltage and differing in the specific phase during the durations for which the switches are set to the specific drive states;
electric current flowing through the specific phase during the durations for which the switches are set to the specific drive states is defined as specific-phase current; and
in the selection step,
the drive pattern is selected, based on the command voltage, such that both a duration for which the switches are set to one of the specific drive states and a duration for which the switches are set to the other of the specific drive states occur within the switching cycle, and
that one of the two modes of the selected drive pattern in which the amount of change in stored charges in the first and second power storage units caused by the specific-phase current is greater is selected based on the command voltage and the electric currents flowing through the windings of the respective phases.
